(19) United States
(12) Patent Application Publication
(10) Pub. No.: US 2006/0120082 A1
(43) Pub. Date: Jun. 8, 2006

(54) Surface light source device, display device having the same, and method of controlling the display device

(76) Inventors: Dae-Ho Choo, Yongin-si (KR); Dae-Kyu Choi, Suwon-si (KR)

Correspondence Address: CANTOR COLBURN, LLP, 55 GRIFFIN ROAD SOUTH, BLOOMFIELD, CT, 06002, US

(21) Appl. No.: 11/282,216

(22) Filed: Nov. 17, 2005

(30) Foreign Application Priority Data
Nov. 17, 2004 (KR) 2004-94280
Aug. 16, 2005 (KR) 2005-74857

(51) Int. Cl. F21V 23/04

(52) U.S. Cl. 362/276; 362/552

(57) ABSTRACT

A surface light source includes a discharge tube, a power source, and a surface light source control part. The discharge tube includes a plurality of lighting areas. Each lighting area has a discharge electrode part. The power source applies electric power to the discharge electrode parts. The surface light source control part separately controls brightness of each lighting area by separately controlling electric power levels applied to the discharge electrode part of each lighting area, respectively. Therefore, relatively high contrasts and relatively low power consumption are obtained.

This application claims priority to Korean Patent Application No. 2004-94280, filed on Nov. 17, 2004, and Korean Patent Application No. 2005-74857 filed on Aug. 16, 2005 and all the benefits accruing therefrom under 35 U.S.C. §119, and the contents of which in their entireties are herein incorporated by reference.

### BACKGROUND OF THE INVENTION

1. Field of the Invention

The present invention relates to a surface light source device, a display device having the same, and a method of controlling the display device. More particularly, the present invention relates to a surface light source device having a brightness adjusting function, a display device having the same, and a method of controlling the display device.

2. Description of the Related Art

In general, a light transmissivity of a liquid crystal is altered corresponding to an electric field applied thereto. A liquid crystal display (“LCD”) device displays an image by controlling the liquid crystal. The LCD device is non-emissive and thus requires light to display the image. Thus, an LCD device includes a backlight unit disposed at a backside of a liquid crystal panel within the LCD device. The backlight unit provides the LCD panel with light.

A cold cathode fluorescent lamp (“CCFL”) and a flat-format fluorescent lamp (“FFFL”) having a fluorescent layer are usable for the backlight unit. An external electrode fluorescent lamp (“EEFL”) having external electrodes disposed on an outer surface of a lamp tube, and a fluorescent lamp having no electrode are also employable as the backlight unit. A fluorescent layer is coated inside of a discharging space of the fluorescent lamp and discharging gases such as xenon Xe, neon Ne, mercury Hg, etc. are introduced in the discharging space.

FIG. 1 is a perspective view illustrating a conventional display device.

Referring to FIG. 1, a conventional display device includes an LCD panel 2 and a backlight assembly 4. The LCD panel 2 has a liquid crystal layer disposed between two substrates. The backlight assembly 4 is disposed under a backside of the LCD panel 2, and the backlight assembly provides the LCD panel 2 with light.

A contrast of an optical image displayed through the display device is affected by brightness of the light generated by the backlight assembly, and ambient luminance. The contrast of an optical image is also affected by display properties of optical images. For example, when a display device expresses a dark scene, a number of displayed pixels is decreased. As a result, a resolution is relatively lowered.

To solve the above-described problem, some techniques are proposed, which flexibly control brightness of a display device according to luminance of surroundings and properties of displayed images. U.S. Pat. No. 5,717,422 discloses a high contrast passive display device that controls brightness of a light source device according to luminance of surroundings and properties of displayed images.

However, brightness controlling of a light source device is performed for the whole light source device. Thus, when a screen is partially dark or bright, obtaining a high contrast is difficult.

Further, when a dark scene is displayed by the controlling of a light source device, power consumption by a light source device may be lowered. However, when a partially bright scene is displayed, brightness of a light source device is totally increased, so that power consumption is still relatively high.

### BRIEF SUMMARY OF THE INVENTION

The present invention provides a surface light source device capable of partially controlling brightness according to properties of images.

The present invention also provides a display device including the surface light source device, which is capable of gaining high contrast and efficiently reducing power consumption by partially controlling brightness of a light source according to properties of images displayed by a display panel of the display device.

The present invention also provides a method of controlling the display device.

In exemplary embodiments of the present invention, a surface light source comprises a discharge tube, a power source, and a surface light source control part. The discharge tube includes a plurality of lighting areas. Each lighting area has a discharge electrode part. The power source applies electric power to each discharge electrode part. The surface light source control part separately controls brightness of each lighting area by separately controlling electric power levels applied to the discharge electrode part of each lighting area, respectively.

In other exemplary embodiments of the present invention, a surface light source apparatus includes a discharge tube, an electromotive force generating part, a power source, a brightness control part, and a surface light source control part. The electromotive force generating part applies an inducted electromotive force inducting plasma discharge to the discharge tube. The power source applies electric power to the electromotive force generating part. The brightness control part is uniformly arranged in the discharge tube. The brightness control part forms a plurality of unit brightness control areas and partially controls brightness of the unit brightness control areas. The surface light source control part separately controls brightness with respect to each unit brightness control area by controlling the brightness control part.

In still other exemplary embodiments of the present invention, a display apparatus comprises a display panel and a surface light source unit. The surface light source unit applies light to the display panel, wherein brightness of the light applied to the display panel by the surface light source unit is partially controlled in response to properties of image signals applied to the display panel.

In further still other exemplary embodiments of the present invention, a method of controlling display apparatus having a display panel and a surface light source unit applying light to the display panel, includes detecting luminance signals and sync signals from image signals outputted from an external image signal source, detecting a maximum luminance value according to each image display area formed in the display panel, and separately driving the surface light source unit, based on a maximum luminance value according to each luminance control area formed in the surface light source unit.

In yet other exemplary embodiments of the present invention, a method of reducing power consumption in a display apparatus includes segmenting a surface light source unit into discrete sections, detecting image signals applied to a display panel, independently controlling the sections of the surface light source unit at least partially in response to the image signals, and applying light from the sections of the surface light source unit to the display panel.

Exemplary embodiments of the surface light source according to the present invention include the upper substrate having the upper electrode formed thereon, and the lower substrate having the plurality lower electrodes that are formed in the lighting areas of the lower substrate, the light areas being defined by spacers. Therefore, the surface light source has a function of controlling brightness according to an area of the surface light source.

Further, when images displayed on the display apparatus, having the exemplary embodiments of the surface light source, are partially dark or bright, relatively high contrasts and relatively low power consumption are obtained by controlling brightness of the light source to be partially dark or bright according to the properties of the images.

### BRIEF DESCRIPTION OF THE DRAWINGS

The above and other advantages of the present invention will become readily apparent by reference to the following detailed description when considered in conjunction with the accompanying drawings wherein:

FIG. 1 is a perspective view illustrating a conventional display device;

FIG. 2 is a block diagram illustrating an exemplary embodiment of a display device according to the present invention;

FIG. 3 is a flow chart showing a control process of controlling an exemplary surface light source in FIG. 2;

FIG. 4 is a schematic view illustrating a structure of an exemplary discharge electrode part disposed in a lighting area in FIG. 2;

FIG. 5 is a schematic view illustrating a structure of another exemplary embodiment of an electrode disposed in a lighting area in FIG. 2;

FIG. 6 is a schematic view illustrating a structure of still another exemplary embodiment of an electrode disposed in a lighting area in FIG. 2;

FIGS. 7A and 7B are graphs showing phase changes of power frequency applied to the exemplary discharge electrode in FIG. 6;

FIG. 8 is a schematic view illustrating a structure of still another exemplary embodiment of an electrode disposed in a lighting area in FIG. 2;

FIG. 9 is a plan view illustrating an exemplary embodiment of a flat discharge tube of a surface light source device according to the present invention;

FIG. 10 is a plan view illustrating another exemplary embodiment of a flat discharge tube of a surface light source device according to the present invention;

FIG. 11 is a plan view illustrating still another exemplary embodiment of a flat discharge tube of a surface light source device according to the present invention;

FIG. 12 is a schematic view illustrating an exemplary embodiment of a display device having a surface light source device using a light emitting diode;

FIG. 13 is a block diagram illustrating another exemplary embodiment of a display device according to the present invention;

FIG. 14 is a circuit diagram illustrating an exemplary embodiment of a switching circuit in FIG. 13;

FIG. 15 is a perspective view illustrating an exemplary embodiment of a surface light source device according to the present invention;

FIG. 16 is a cross-sectional view illustrating the exemplary surface light source device in FIG. 15;

FIG. 17 is another cross-sectional view illustrating the exemplary surface light source device in FIG. 15;

FIG. 18 is a cross-sectional view illustrating another exemplary embodiment of a surface light source device according to the present invention;

FIG. 19 is a cross-sectional view illustrating still another exemplary embodiment of a surface light source device according to the present invention;

FIG. 20 is a perspective view illustrating still another exemplary embodiment of a surface light source device according to the present invention;

FIG. 21 is a cross-sectional view illustrating the exemplary surface light source device in FIG. 20;

FIG. 22 is a cross-sectional view illustrating the exemplary embodiment of a surface light source device according to the present invention;

FIG. 23 is a cross-sectional view illustrating still another exemplary embodiment of a surface light source device according to the present invention;

FIG. 24 is a plan view illustrating another exemplary embodiment of a surface light source device according to the present invention;

FIG. 25 is a cross-sectional view illustrating still another exemplary embodiment of a surface light source device according to the present invention;

FIG. 26 is a cross-sectional view illustrating still another exemplary embodiment of a surface light source device according to the present invention;

FIG. 27A is an exploded perspective view illustrating still another exemplary embodiment of a display device according to the present invention;

FIG. 27B is an enlarged view illustrating portion ‘A’ in FIG. 27A;

FIG. 28 is a plan view illustrating an exemplary arrangement of electrodes of a backlight unit in FIG. 27A;

FIG. 29 is a block diagram illustrating an exemplary driving circuit of a backlight unit in FIG. 28;

FIG. 30 is a flow chart showing an exemplary operation of the exemplary driving circuit of a backlight unit in FIG. 29;

FIG. 31 is a block diagram illustrating an exemplary backlight control part in FIG. 29;

FIG. 32A is a conceptual view illustrating a process of dividing image signals of one frame into horizontal sections;

FIG. 32B is an enlarged view illustrating portion ‘B’ in FIG. 32A;

FIG. 33 is a conceptual view illustrating a process of dividing one horizontal scanning line into vertical sections;

FIG. 34 is a conceptual view illustrating a process of dividing a plurality of horizontal scanning lines forming one horizontal section into vertical sections;

FIG. 35 is a flow chart illustrating stages detecting a maximum luminance value of each image display section;

FIGS. 36A to 36C are conceptual views showing a process of detecting maximum voltage about horizontal and vertical sections;

FIG. 37 is a flow chart showing a method of driving the exemplary backlight unit in FIG. 29;

FIG. 38 is a timing diagram showing a maximum voltage value outputted from first and second registers of an exemplary backlight control part;

FIG. 39 is a circuit diagram illustrating an exemplary horizontal driving part and an exemplary vertical driving part in FIG. 29;

FIG. 40 is a conceptual view showing a waveform of each important nodes of an exemplary horizontal driving part;

FIG. 41 is a waveform diagram showing a change of duty according to a change of a maximum voltage value of a horizontal section;

FIG. 42 is a timing diagram illustrating an operation of an exemplary horizontal driving part in FIG. 29;

FIG. 43 is a timing diagram illustrating an operation of an exemplary vertical driving part in FIG. 29; and

FIG. 44 is a conceptual view illustrating an example of controlling luminance performed by a luminance control part of a backlight unit as distribution of an image luminance displayed on a liquid crystal display panel.

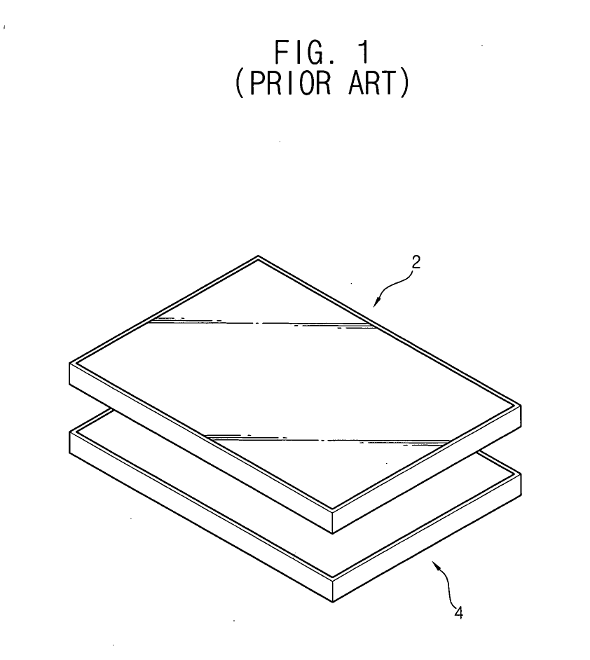

### DETAILED DESCRIPTION OF THE INVENTION

It should be understood that the exemplary embodiments of the present invention described below may be varied and modified in many different ways without departing from the inventive principles disclosed herein, and the scope of the present invention is therefore not limited to these particular following embodiments. Rather, these embodiments are provided so that this disclosure will be thorough and by way of example and not of limitation.

Hereinafter, the present invention will be explained in detail with reference to the accompanying drawings. In the drawings, certain features or regions may be exaggerated or eliminated for clarity. Like numerals refer to like elements throughout.

### Embodiments of Display Devices

### Embodiment 1

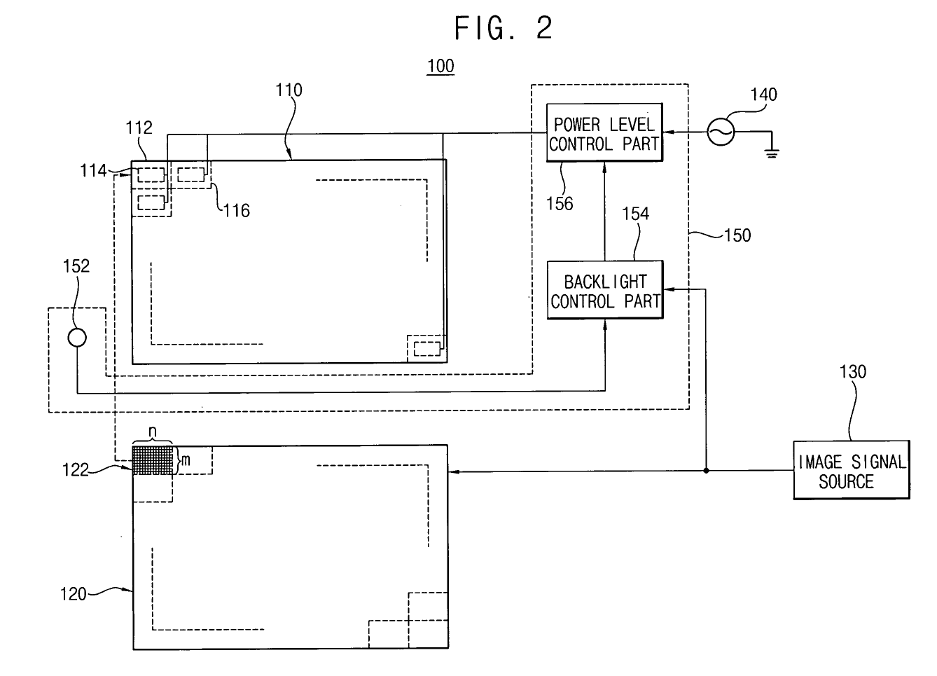

FIG. 2 is a block diagram illustrating an exemplary embodiment of a display device according to the present invention.

Referring to FIG. 2, a display device 100 includes a flat discharge tube 110, a display panel part 120, an image signal source 130, a power source 140, and a surface light source control part 150.

The flat discharge tube 110 includes discharge electrodes 114 formed in each of a plurality of lighting areas 112. The lighting areas 112 are divided or defined by spacers 116 and have, by example only, tetragonal, circular, or polygonal shapes. While only a few lighting areas 112 are illustrated, it should be understood that the flat discharge tube 110 may include lighting areas 112 within an entire light emitting area of the flat discharge tube 110.

The display panel part 120 is disposed on the flat discharge tube 110 and includes a plurality of pixel groups 122. The pixel groups 122 are grouped into n x m pixels. Preferably, a size of the pixel groups 122 may be substantially the same as a size of a lighting area 112 disposed in the flat discharge tube 110. In other words, more pixel groups 122 may be formed on the display panel part 120 than are illustrated. The flat discharge tube 110 is disposed on a backside of the display panel part 120.

The display panel part 120 includes a liquid crystal panel having an array substrate, an opposite substrate such as a color filter substrate, and a liquid crystal layer. A plurality of thin film transistors (“TFTs”) is disposed in the array substrate. The array substrate faces the opposite substrate. The liquid crystal layer is disposed between the array substrate and the opposite substrate. The display panel part 120 includes a gate driving part (not shown) and a source driving part (not shown). The gate driving part activates a gate line that is electrically connected to a gate electrode of the TFTs. The source driving part applies power corresponding to an image signal to a source line electrically connected to a source electrode of the TFTs.

The image signal source 130 is, for example, a graphic controller formed in an external device such as a host. The image signal source 130 applies image signals to the display panel part 120 and surface light source control part 150.

The power source 140 applies electric power for driving a plurality of discharge electrodes to the surface light source control part 150.

The surface light source control part 150 includes a light sensor 152, a backlight control part 154, and a power level control part 156. The surface light source control part 150 separately controls brightness of each lighting area 112 by separately controlling power levels applied to each discharge electrode 114 according to an ambient luminance and image signal properties from the image signal source 130.

More particularly, the light sensor 152 senses the ambient luminance and applies a signal corresponding to the sensed ambient luminance to the backlight control part 154.

The backlight control part 154 checks properties of image signals provided from the image signal source 130 and brightness signals from the light sensor 152. According to the result determined from the properties, the backlight control part 154 applies controlling signals of a power level for controlling brightness of each lighting area 112 to the power level control part 156.

Power from the power source 140 is applied to the power level control part 156. The power level control part 156 controls power levels applied to each discharge electrode 114 of each lighting area 112, according to properties of image signals from the image signal source 130.

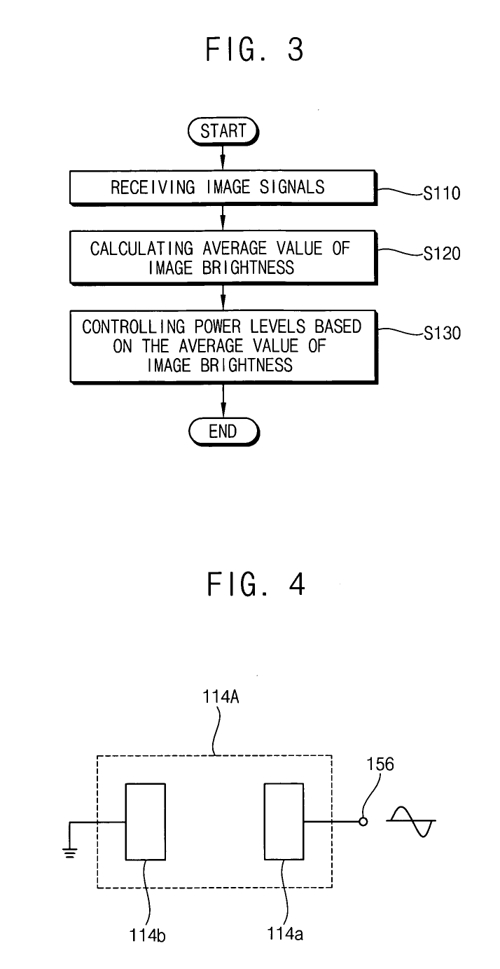

FIG. 3 is a flow chart showing a control process of controlling an exemplary surface light source in FIG. 2.

Referring to FIGS. 2 and 3, the surface light source control part 150 receives image signals from the image signal source 130, as demonstrated by step S110. The image signals include video signals having luminance signals and horizontal and vertical sync (synchronization) signals.

Subsequently, the surface light source control part 150 calculates an average value of image brightness corresponding to each lighting area 112 of the flat discharge tube 110, as shown by step S120.

Subsequently, the surface light source control part 150 controls power levels corresponding to each lighting area 112, based on the average value of image brightness, as shown by step S130.

### Embodiment 1 of a Discharge Electrode

FIG. 4 is a schematic view illustrating a structure of an exemplary embodiment of a discharge electrode part disposed in a lighting area in FIG. 2.

Referring to FIG. 2 and FIG. 4, a discharge electrode part 114A includes a first discharge electrode 114a connected to the power level control part 156 and a second discharge electrode 114b facing the first discharge electrode 114a. The second discharge electrode 114b is electrically connected to a ground voltage terminal. The first and second discharge electrodes 114a and 114b have a flat-shape and receive electric power, of which level is controlled according to image properties, from the power level control part 156.

### Embodiment 2 of a Discharge Electrode

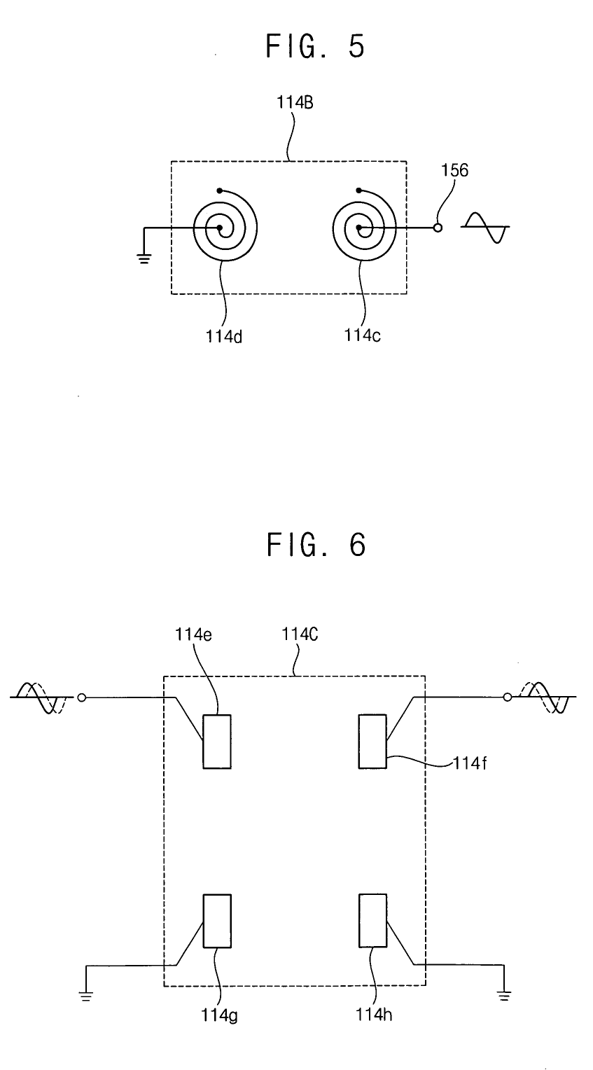

FIG. 5 is a schematic view illustrating another exemplary embodiment of a structure of an electrode disposed in a lighting area in FIG. 2.

Referring to FIG. 2 and FIG. 5, a discharge electrode part 114B includes a third discharge electrode 114c electrically connected to the power level control part 156 and a fourth discharge electrode 114d facing the third discharge electrode 114c. The fourth discharge electrode 114d is electrically connected to ground voltage terminal. The third and fourth discharge electrodes 114c and 114d have a flat-spiral-shape and receive electric power, of which level is controlled according to image properties, from the power level control part 156.

### Embodiment 3 of a Discharge Electrode

FIG. 6 is a schematic view illustrating still another exemplary embodiment of a structure of an electrode disposed in a lighting area in FIG. 2.

Referring to FIG. 2 and FIG. 6, a discharge electrode part 114C includes fifth, sixth, seventh, and eighth discharge electrodes 114e, 114f, 114g, and 114h disposed at each corner of the discharge electrode part 114C and electrically connected to the power level control part 156 or the ground voltage terminal. In other words, the fifth and eighth discharge electrodes 114e and 114h are diagonally disposed at first and second corners diagonal to each other, respectively, and the sixth and seventh discharge electrodes 114f and 114g are diagonally disposed at third and fourth corners diagonal to each other, respectively. The fifth and sixth discharge electrodes 114e and 114f face each other and are electrically connected to the power level control part 156. The seventh and eighth discharge electrodes 114g and 114h face each other and are electrically connected to the ground voltage terminal. The fifth to eighth discharge electrodes 114e, 144f, 144g, 114h have a flat-shape and receive electric power, of which level is controlled according to image properties, from the power level control part 156. Each frequency of power applied to the fifth and sixth discharge electrodes 114e and 114f has a different phase.

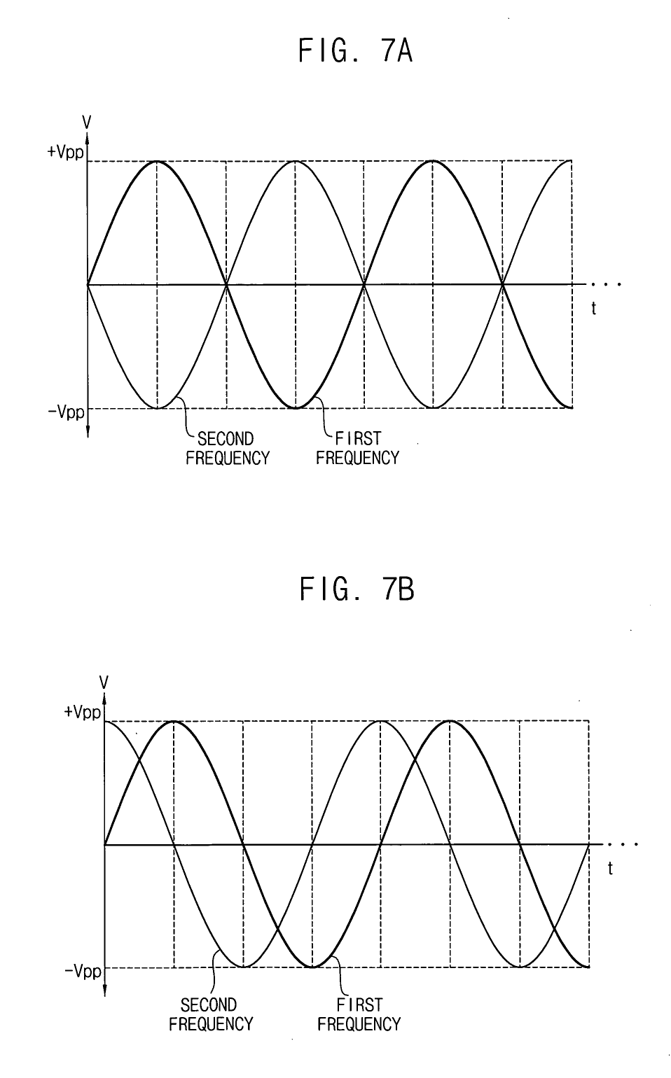

FIGS. 7A and 7B are graphs showing phase changes of power frequency applied to the exemplary discharge electrodes in FIG. 6.

Referring to FIGS. 6 and 7A, for example, an electric power having a first frequency is applied to the fifth discharge electrode 114e and an electric power having a second frequency is applied to the sixth discharge electrode 114f. In this embodiment, the first and second frequencies have a phase difference of about 180 degrees. In FIG. 7A, +Vₚₚ represents a maximum value of a voltage of the power, and −Vₚₚ represents a minimum value of a voltage of the power.

Referring to FIG. 6 and FIG. 7B, as another example, an electric power having a first frequency is applied to the fifth discharge electrode 114e and an electric power having a second frequency is applied to the sixth discharge electrode 114f. In this embodiment, the first and second frequencies have a phase difference of about 90 degrees.

### Embodiment 4 of a Discharge Electrode

FIG. 8 is a schematic view illustrating still another exemplary embodiment of a structure of an electrode disposed in a lighting area in FIG. 2.

Referring to FIGS. 2 and 8, a discharge electrode part 114D includes ninth, tenth, eleventh, and twelfth discharge electrodes 114i, 114j, 114k, and 114l disposed at each corner of the discharge electrode part 114D and electrically connected to the power level control part 156 or the ground voltage terminal. In other words, the ninth and twelfth discharge electrodes 114i and 114l are disposed at first and second corners diagonal to each other, respectively, and the tenth and eleventh discharge electrodes 114j and 114k are disposed at third and fourth corners diagonal to each other. The ninth and tenth discharge electrodes 114i and 114j face each other and are electrically connected to the power level control part 156. The eleventh and twelfth discharge electrodes 114k and 114l face each other and are electrically connected to the ground voltage terminal. The ninth to twelfth discharge electrodes 114i, 114j, 114k, 114l have a flat spiral-shape and receive an electric power, of which level is controlled according to image properties, from the power level control part 156. Each frequency of electric power applied to the ninth and tenth discharge electrodes 114i and 114j has a different phase.

### Embodiment 1 of a Flat Discharge Tube

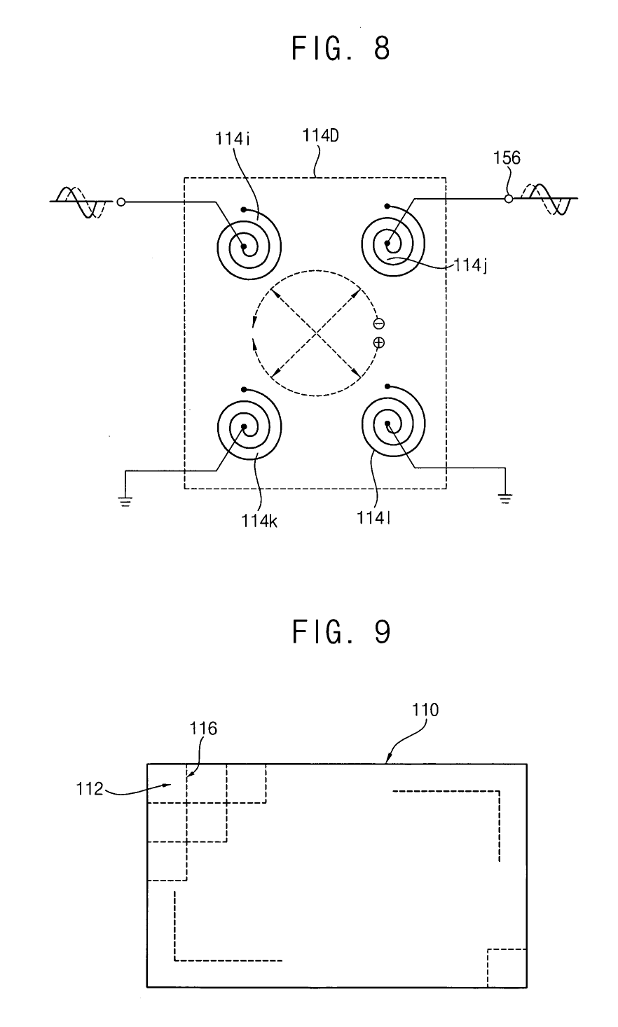

FIG. 9 is a plan view illustrating an exemplary embodiment of a flat discharge tube of a surface light source device according to the present invention.

Referring to FIG. 9, a flat discharge tube 110 of a surface light source includes a plurality of tetragonal-shaped lighting areas 112, where the axes of the shape are at right angles to each other to form a rectangular prism with a square base and a height having a length different than a side of the square base. The lighting areas 112 are divided or defined by a spacer 116. A pair of flat-shaped lighting electrodes as shown in FIG. 4 or a pair of flat-spiral-shaped lighting electrodes as shown in FIG. 5 is optionally formed in the lighting areas. Alternatively, two pairs of flat-shaped discharge electrodes or two pairs of flat-spiral-shaped discharge electrodes as shown in FIG. 6 and FIG. 8, respectively, are optionally formed in the lighting areas 112.

### Embodiment 2 of a Flat Discharge Tube

FIG. 10 is a plan view illustrating another exemplary embodiment of a flat discharge tube of a surface light source device according to the present invention.

Referring to FIG. 10, a flat discharge tube 110a of a surface light source includes a plurality of cylindrical shaped lighting areas 112a. The lighting areas 112a are divided or defined by a spacer 116a. The spacer 116a includes cylindrical shaped regions for defining the cylindrical shaped lighting areas 112a.

### Embodiment 3 of a Flat Discharge Tube

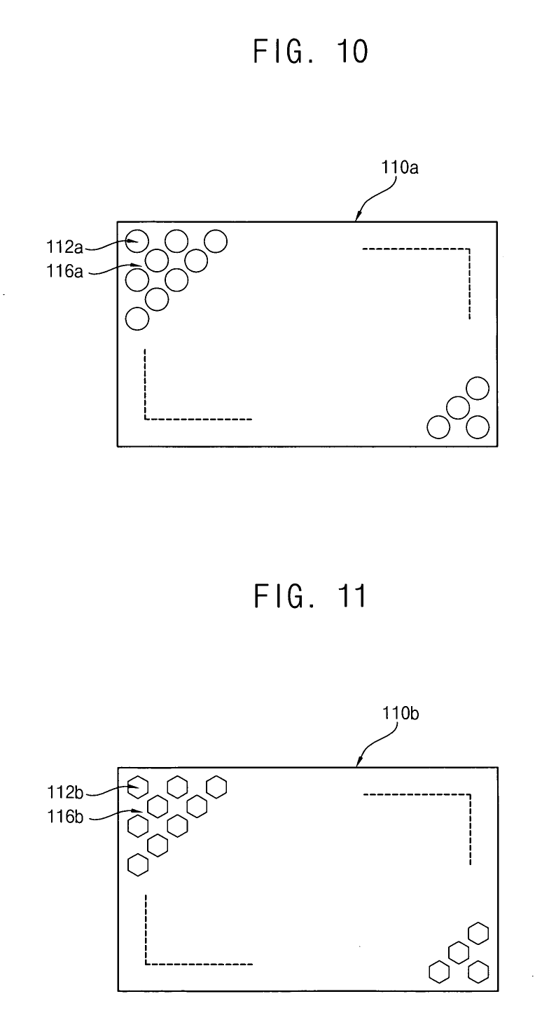

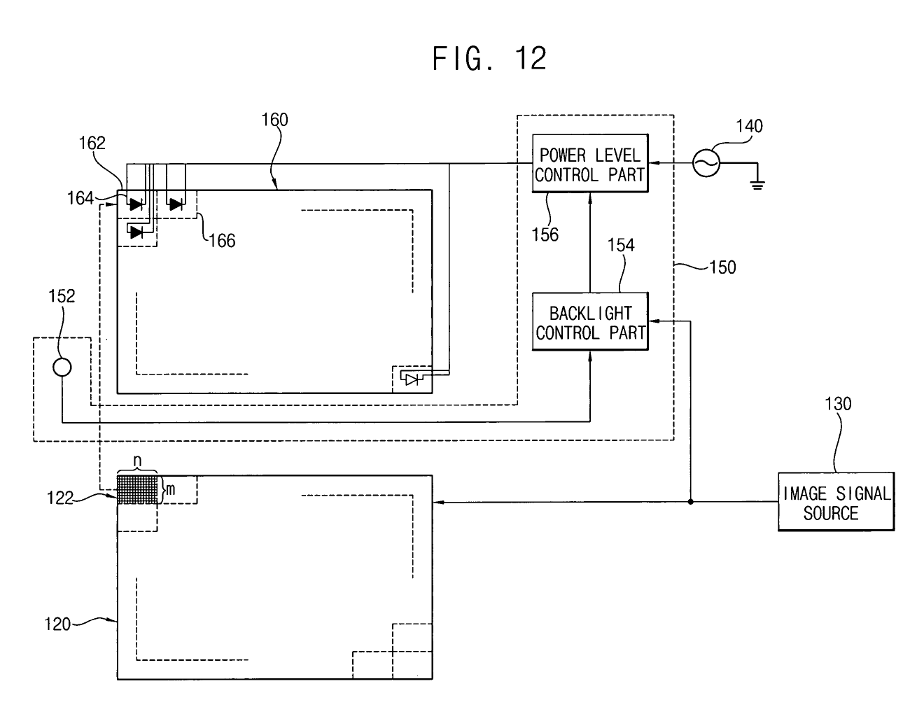

FIG. 11 is a plan view illustrating still another exemplary embodiment of a flat discharge tube of a surface light source device according to the present invention.

Referring to FIG. 11, a flat discharge tube 110b of a surface light source includes a plurality of hexagonal-shaped lighting areas 112b. The lighting areas 112b are divided or defined by a spacer 116b. The spacer 116b includes hexagonal-shaped regions for defining the hexagonal-shaped lighting areas 112b.

While tetragonal, cylindrical, and hexagonal shaped lighting areas 112 have been described, alternate shapes of lighting areas 112 and correspondingly shaped spacers 116 would also be within the scope of these embodiments.

Various light sources, especially point sources of light, are optionally formed in the above-described lighting areas 112. For example, a light emitting diode, as one example of a light source, is formed.

FIG. 12 is a schematic view illustrating an exemplary embodiment of a display device having a surface light source device using a light emitting diode.

Referring to FIG. 12, a display device includes a flat discharge tube 160, display panel part 120, an image signal source 130, a power source 140, and a surface light source control part 150.

The same reference numerals will be used to refer to the same or like parts as those described in FIG. 2, and thus any further explanations will be omitted.

The flat discharge tube 160 includes diodes 164 formed in a plurality of lighting areas 162. The lighting areas 162 are divided or defined by a spacer 166 and have, for example, tetragonal-shaped, cylindrical shaped, or polygonal-shaped structures. An anode and a cathode of the diodes 164 are separately connected to the power level control part 156 and receive electric powers of different levels, respectively.

### Embodiment 2 of a Display Device

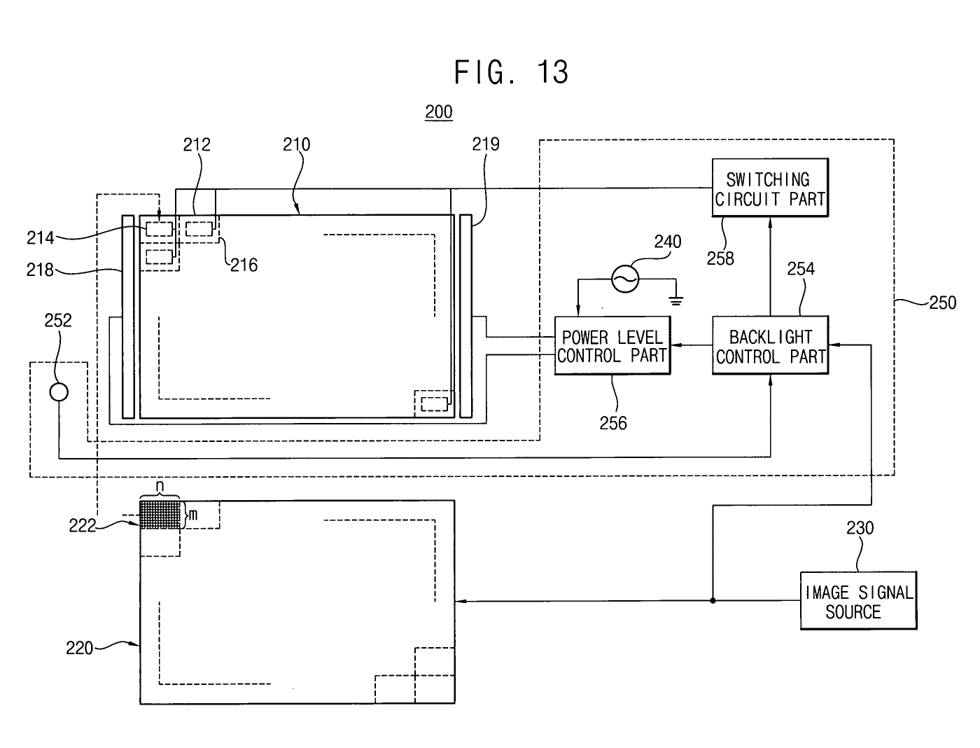

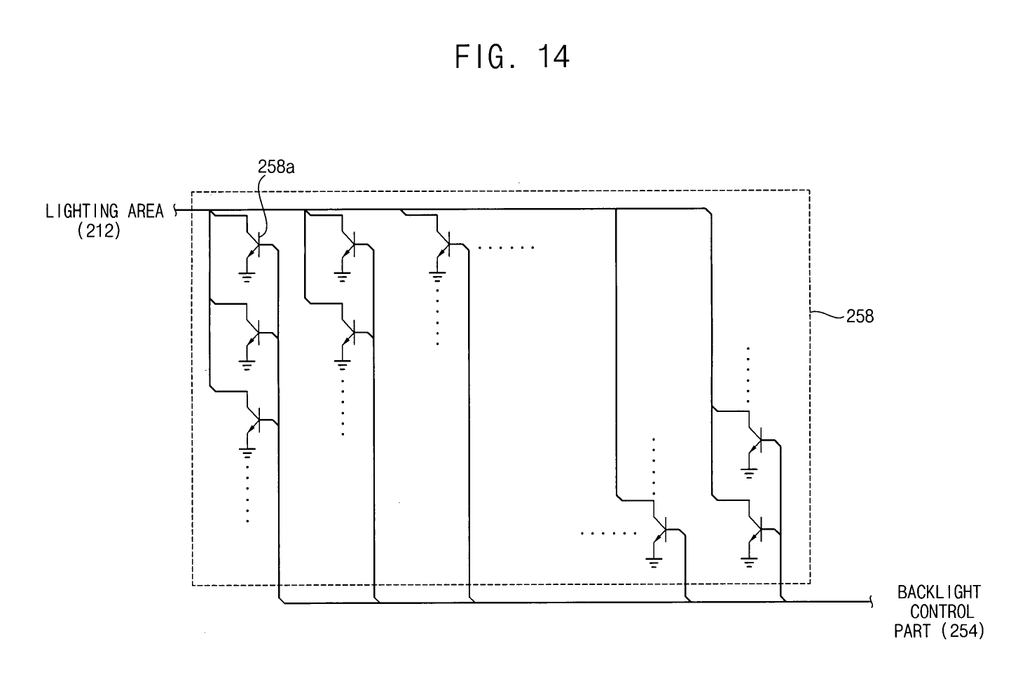

FIG. 13 is a block diagram illustrating another exemplary embodiment of a display device according to the present invention.

Referring to FIG. 13, a display device 200 includes a flat discharge tube 210, a first electromotive force generating part 218, a second electromotive force generating part 219, a display panel part 220, an image signal source 230, a power source 240, and a surface light source control part 250.

The flat discharge tube 210 includes discharge electrodes 214 formed in a plurality of lighting areas 212. The lighting areas 212 are divided or defined by a spacer 216 and have, for example, tetragonal-shaped, cylindrical shaped, or polygonal-shaped structures.

The first electromotive force generating part 218 is disposed at one side of the flat discharge tube 210 and applies electromotive force for inducing plasma discharge to the flat discharge tube 210. The second electromotive force generating part 219 is disposed at another side, such as an opposite side, of the flat discharge tube 210 and applies electromotive force for inducing plasma discharge to the flat discharge tube 210. The first and second electromotive force generating parts 218 and 219 include a flat discharge electrode, a ferrite core, and a coil (not shown). The flat discharge electrode and the ferrite core is disposed at both ends of the flat discharge tube 210. The coil is wound around the ferrite core. A first end of the coil is electrically connected to the flat discharge electrode within the first and second electromotive force generating parts 218, 219 and a second end of the coil is electrically connected to the power source 240.

The display panel part 220 is disposed on the flat discharge tube 210 and includes a plurality of pixel groups 222. The pixel groups 222 are grouped into n×m pixels. Preferably, a size of the pixel groups 222 is substantially the same as a size of a lighting area 212 disposed in the flat discharge tube 210. The flat discharge tube 210 is disposed on a backside of the display panel part 220.

The image signal source 230 is, for example, a graphic controller formed in an external device such as a host. The image signal source 230 applies image signals to the display panel part 220 and surface light source control part 250.

The power source 240 applies electric power for driving a plurality of discharge electrodes 214 to the surface light source control part 250.

The surface light source control part 250 includes a light sensor 252, a backlight control part 254, a power level control part 256, and a switching circuit part 258. The surface light source control part 250 separately controls brightness of each lighting area 212 by separately controlling power levels applied to each discharge electrode 214 according to an ambient luminance and image signal properties from the image signal source 230.

In detail, the light sensor 252 senses an ambient luminance and applies a signal corresponding to the sensed ambient luminance to the backlight control part 254 of the surface light source control part 250.

The backlight control part 254 checks properties of image signals provided from the image signal source 230 and brightness signals from the light sensor 252. According to the result determined from the properties, the backlight control part 254 applies controlling signals of a power level for controlling brightness of each lighting area 212 to the power level control part 256, and the backlight control part 254 provides a controlling lighting signal for turning on or off light of each lighting area 212 to the switching circuit part 258.

Power from the power source 240 is applied to the power level control part 256. The power level control part 256 controls power levels applied to each discharge electrode 214 of each respective lighting area 212, according to properties of image signals from the image signal source 230.

When a controlling lighting signal from the backlight control part 254 is applied to the switching circuit part 258, the switching circuit part 258 partially turns on or off the flat discharge tube 210 according to the lighting areas 212. That is, the light areas 212 are separately controlled by the switching circuit part 258.

FIG. 14 is a circuit diagram illustrating an exemplary embodiment of a switching circuit in FIG. 13.

Referring to FIGS. 13 and 14, the switching circuit part 258 includes a plurality of bipolar transistors 258a corresponding to the discharge electrodes 214 formed in the flat discharge tube 210, respectively. The bipolar transistors 258a are three terminal semiconductor devices. Under the control of the base terminal, current can flow selectively from the collector terminal to the emitter terminal, such as in the direction of the arrow illustrated in FIG. 14. Each bipolar transistor 258a is electrically connected to a discharge electrode 214 formed in one lighting area 212. The emitter terminal of each bipolar transistor 258a is electrically connected to a ground voltage terminal, the base terminal of each bipolar transistor 258a is electrically connected to the backlight control part 254, and the collector terminal of each bipolar transistor 258a is electrically connected to the discharge electrodes 214.

During an operation, the bipolar transistor 258a is turned on or off corresponding to a controlling lighting signal from the backlight control part 254, so that the discharge electrode 214 is connected or disconnected to a ground voltage terminal.

In FIG. 14, each base terminal of a bipolar transistor 258a is electrically connected to the backlight control part 254 through a line and each collector terminal of a bipolar transistor 258a is electrically connected to the discharge electrode 214 to control power supply. A plurality of lines corresponding to bipolar transistors 258a, respectively, may be formed to separately supply electric powers to the bipolar transistors 258a.

### Embodiment 1 of a Surface Light Source Device

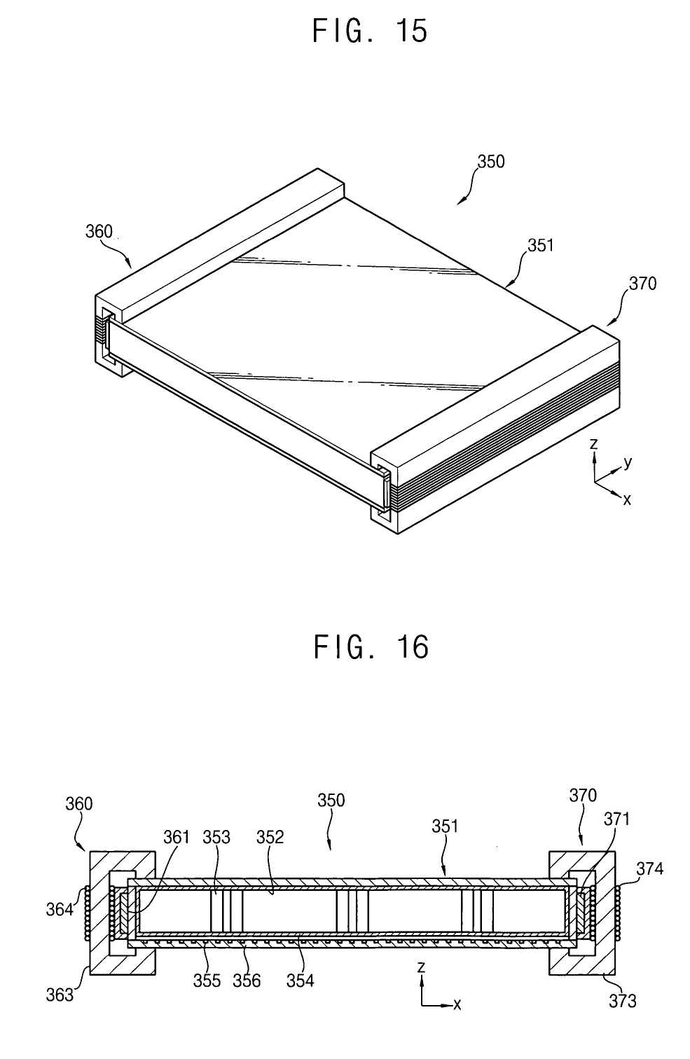

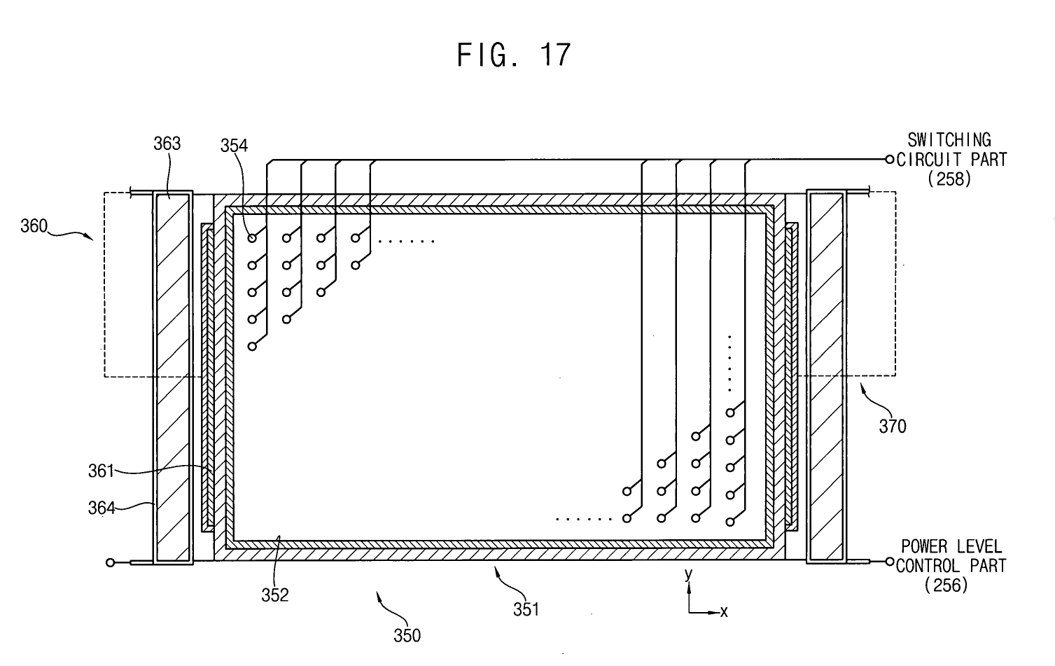

FIG. 15 is a perspective view illustrating an exemplary embodiment of a surface light source device according to the present invention. FIG. 16 is a cross-sectional view illustrating the exemplary surface light source device in FIG. 15. FIG. 17 is another cross-sectional view illustrating the exemplary surface light source device in FIG. 15.

Referring to FIGS. 15 to 17, a surface light source device 350 includes a flat discharge tube 351, a first electromotive force generating part 360, and a second electromotive force generating part 370. The surface light source device 350 emits light of which luminance is adjusted according to properties of image signals. The first and second electromotive force generating parts 360 and 370 cover first and second end portions of the flat discharge tube 351, respectively.

The flat discharge tube 351 includes two substrates facing each other, an upper electrode and a lower electrode dividing or defining a plurality of lighting areas. The flat discharge tube 351 emits light according to electric powers separately provided from the first and second electromotive force generating parts 360 and 370 to each lighting area.

FIG. 16 shows an upper electrode 352 formed on an entire surface of an upper substrate and the lower electrode 354 formed on lighting areas arranged in a lower substrate. Referring to FIG. 16, a plurality of diffusion members 355 and reflecting members 356 covering the diffusion members 355 are additionally formed on a backside of the lower substrate. The diffusion members 355 enhance uniformity of light. The reflecting member 356 enhances light-using efficiency by reflecting light toward +z-axis.

The lighting areas are divided by a spacer 353 that maintains a predetermined distance between the upper and lower substrates. The lighting areas divided by the spacer 353 may have various structures such as tetragonal, circular, and polygonal structures, etc., when viewed on a plane.

The first electromotive force generating part 360 includes a first flat discharge electrode 361, a first ferrite core 363, and a first coil 364. The first flat discharge electrode 361 is disposed at a first end portion of the flat discharge tube 351. The first ferrite core 363 has a C-shape or U-shape and clips an edge portion of the flat discharge tube 351. The first coil 364 is wound around the first ferrite core 363. One end of the first coil 364 is connected to the first flat discharge electrode 361 and the other end of the first coil 364 is connected to a power source.

The second electromotive force generating part 370 includes a second flat discharge electrode 371, a second ferrite core 373, and a second coil 374. The second flat discharge electrode 371 is disposed at a second end portion of the flat discharge tube 351 and faces the first electromotive force generating part 360. The first and second end portions are opposite to each other. The second ferrite core 373 has a C-shape or U-shape and clips an edge portion of the flat discharge tube 351. The second coil 374 is wound around the second ferrite core 373. One end of the second coil 374 is electrically connected to the second flat discharge electrode 371 and the other end of the second coil 374 is connected to a power source.

Thus, in a first exemplary embodiment of a surface light source device according to the present invention, the surface light source device includes an upper electrode formed on a surface of a upper substrate, a plurality of light emitting areas divided by spacers, and a plurality of lower electrodes disposed in the lighting areas, respectively. As a result, the surface light source device has a partially driving function.

### Embodiment 2 of a Surface Light Source Device

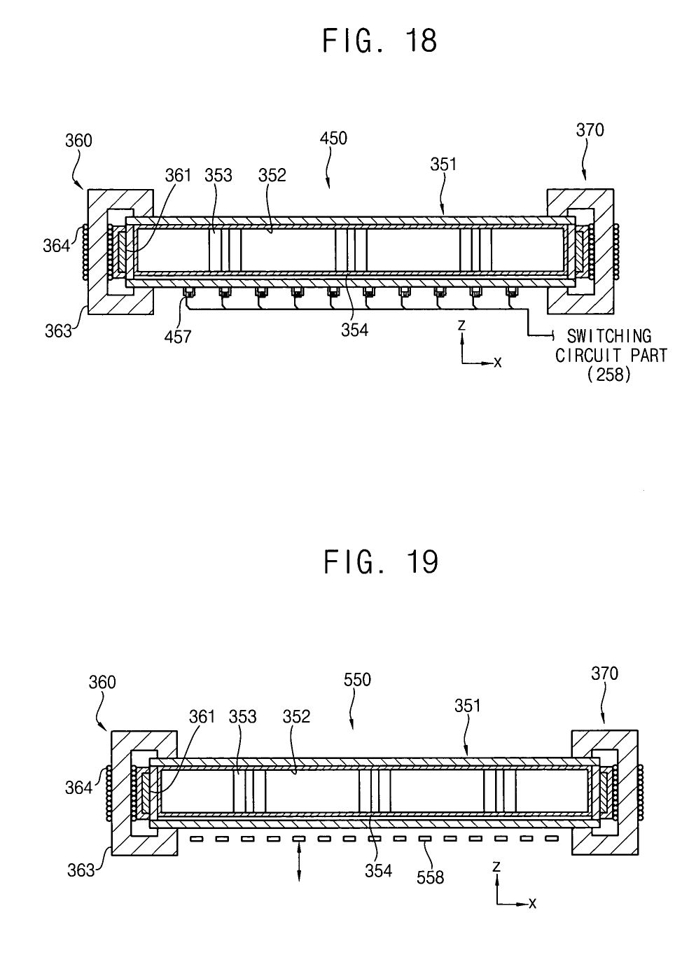

FIG. 18 is a cross-sectional view illustrating another exemplary embodiment of a surface light source device according to the present invention.

Referring to FIG. 18, a surface light source device 450 includes a flat discharge tube 351, a first electromotive force generating part 360, a second electromotive force generating part 370, and a plurality of cores 457, such as ferrite cores. The plurality of cores 457 is disposed on a backside of the flat discharge tube 351. Each of the cores 457 is small and single wired. A coil may be wound around the cores 457. The surface light source device 450 emits light, when the surface light source device 450 receives electric powers controlled by each property of image signals. The same reference numerals are used to refer to the same or like parts as those described in FIGS. 15 to 17, and any further explanations will be omitted.

### Embodiment 3 of a Surface Light Source Device

FIG. 19 is a cross-sectional view illustrating still another exemplary embodiment of a surface light source device according to the present invention.

Referring to FIG. 19, a surface light source device 550 includes a flat discharge tube 351, a first electromotive force generating part 360, a second electromotive force generating part 370, and a plurality of permanent magnets 558. The plurality of permanent magnets 558 is disposed on a backside of the flat discharge tube 351. The surface light source device 550 emits light when the surface light source device 550 receives electric powers controlled by each property of image signals. The same reference numerals are used to refer to the same or like parts as those described in FIGS. 15 to 17, and any further explanations will be omitted.

### Embodiment 4 of a Surface Light Source Device

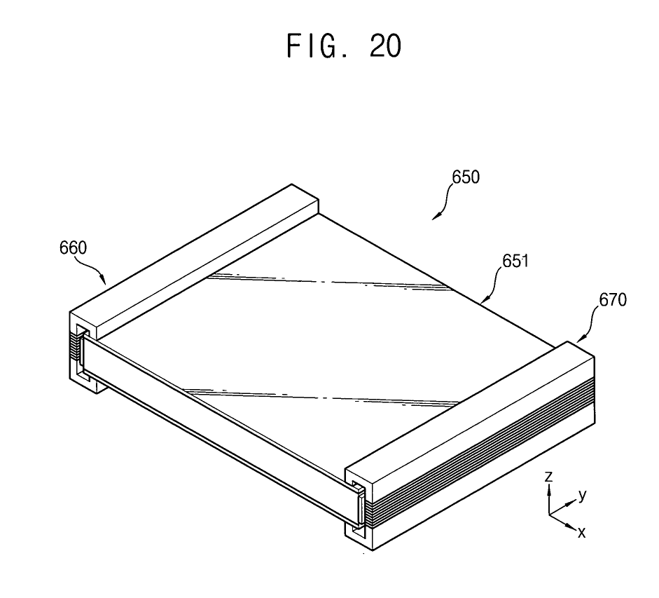

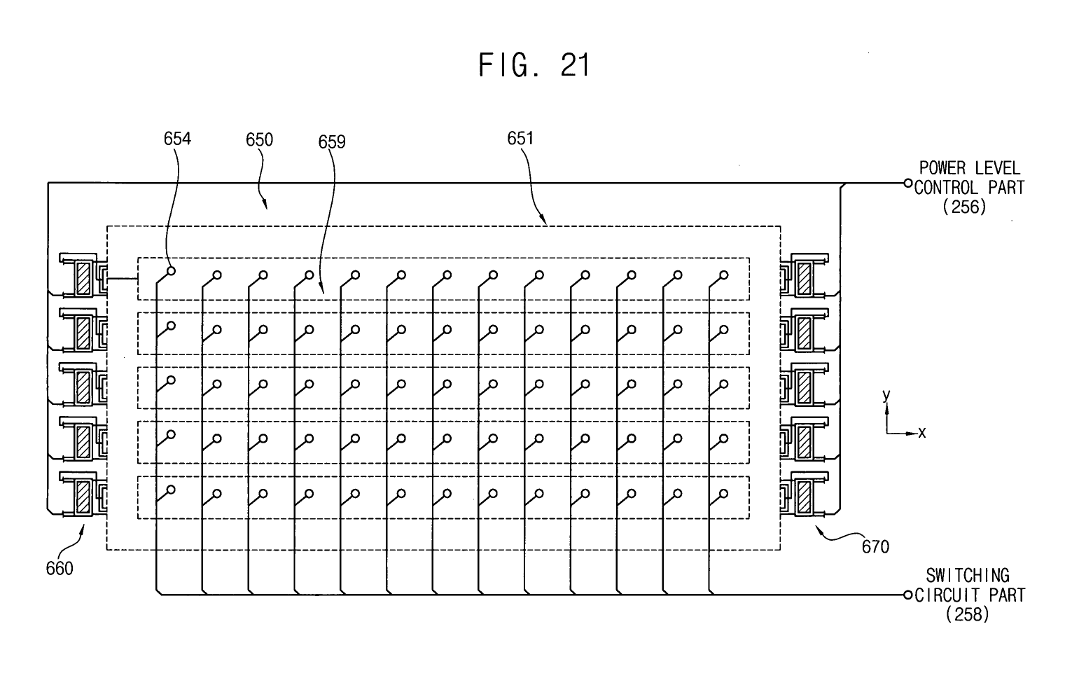

FIG. 20 is a cross-sectional view illustrating still another exemplary embodiment of a surface light source device according to the present invention. FIG. 21 is a cross-sectional view illustrating the exemplary surface light source device in FIG. 20.

Referring to FIGS. 20 and 21, a surface light source device 650 includes a flat discharge tube 651, a first electromotive force generating part 660, and a second electromotive force generating part 670. The surface light source device 650 emits light when the surface light source device 650 receives electric power controlled by each property of image signals. The first electromotive force generating part 660 covers a first edge portion area of the flat discharge tube 651. The second electromotive force generating part 670 covers a second edge portion of the flat discharge tube 651. The first edge portion is opposite to the second edge portion.

The flat discharge tube 651 includes an upper substrate, a lower substrate facing the upper substrate, an upper electrode 659 that is formed on the upper substrate and defines lighting areas, and a lower electrode 654 formed on the lower substrate such that the lower electrode 654 corresponds to the lighting areas.

The flat discharge tube 651 emits light in response to turning on or off signals from the switching circuit part 258 and electric powers separately applied to each lighting area, respectively from the first and second electromotive force generating parts 660 and 670.

The upper electrode 659 has a horizontally patterned band-shape and defines lighting areas. A first side portion of the upper electrode 659 adjacent the first edge portion of the flat discharge tube 651 is electrically connected to the first electromotive force generating part 660. A second side portion of the upper electrode 659 adjacent the second edge portion of the flat discharge tube 651 is electrically connected to the second electromotive force generating part 670. The first and second side portions of the upper electrode 659 are opposite to each other.

The first electromotive force generating part 660 includes a plurality of first sub electromotive force generating parts. The first electromotive force generating part 660 applies electric powers provided from the power level control part 256 to the upper electrode 659.

The first sub electromotive force generating parts are disposed at the first edge portion of the flat discharge tube 651 such that the first sub electromotive force generating parts are spaced apart from each other. Each of the first sub electromotive force generating parts includes a first flat discharge electrode, a first ferrite core, and a first coil. The first ferrite core has a C-shape or U-shape and clips the first edge portion of the flat discharge tube 651. The first coil is wound around the first ferrite core. An end of the first coil is electrically connected to the first flat discharge electrode and the other end of the first coil is electrically connected to a power source.

The second electromotive force generating part 670 includes a plurality of second sub electromotive force generating parts. The second electromotive force generating part 670 is disposed at the second edge portion of the flat discharge tube 651 and applies power from the power level control part 256 to the second side portion of the upper electrode 659.

The second sub electromotive force generating parts are arranged in the second edge portion of the flat discharge tube 651 such that the second sub electromotive force generating parts are spaced apart from each other.

Each of the second sub electromotive force generating parts includes a second flat discharge electrode, a second ferrite core, and a second coil. The second flat discharge electrode is disposed at the second end of a plurality of discharge areas of the flat discharge tube 651 and faces the first electromotive force generating part 660. The second ferrite core has a C-shape or U-shape and clips the second edge portion of the flat discharge tube 651. The second coil is wound around the second ferrite core. One end of the second coil is electrically connected to the second flat discharge electrode and the other end of the second coil is electrically connected to a power source.

Thus, according to this embodiment, the surface light source device includes an upper electrode having a patterned band-shape and defining lighting areas and a plurality of lower electrodes corresponding to the lighting areas. As a result, the surface light source device has a partially driving function.

### Embodiment 5 of a Surface Light Source Device

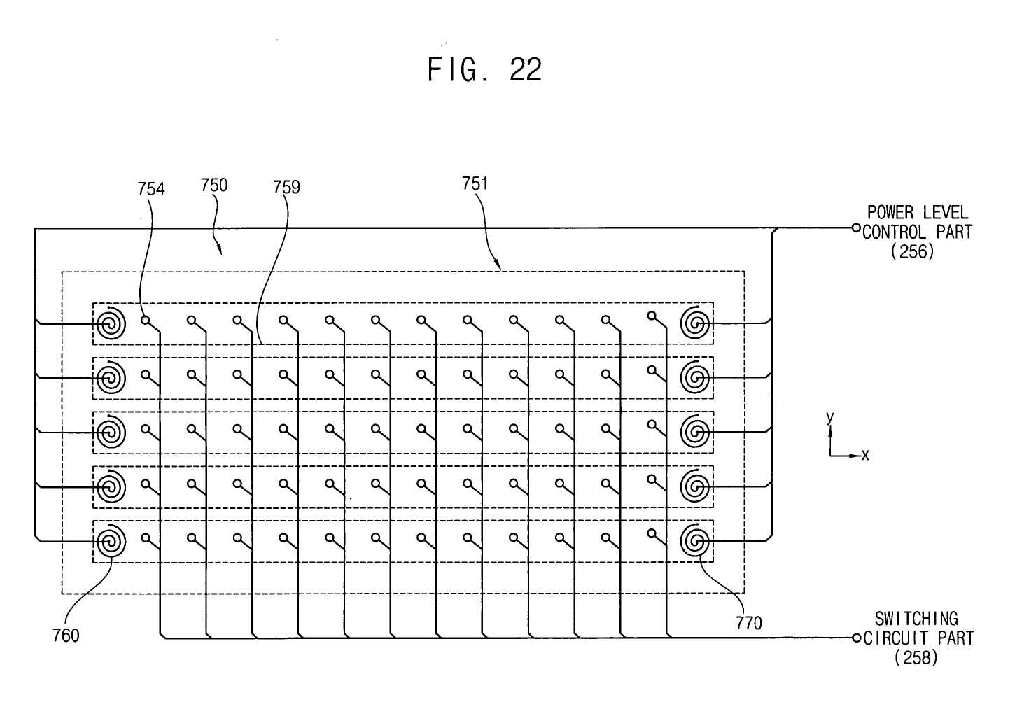

FIG. 22 is a cross-sectional view illustrating an exemplary embodiment of a surface light source device according to the present invention.

Referring to FIG. 22, a surface light source device 750 includes a flat discharge tube 751, a first antenna electrode part 760 formed at a first edge portion of the flat discharge tube 751, and a second antenna electrode part 770 formed at a second edge portion of the flat discharge tube 751. The surface light source device 750 emits light when the surface light source device 750 receives electric powers, of which levels are controlled by properties of image signals.

The flat discharge tube 751 includes an upper substrate, a lower substrate facing the upper substrate, an upper electrode 759 formed on the upper substrate and defining lighting areas, and lower electrodes 754 formed on the lower substrate and corresponding to the lighting areas.

The flat discharge tube 751 emits light when the flat discharge tube 751 receives electric powers separately applied to each lighting area from the first and second antenna electrode parts 760 and 770 in response to turning on or off signals provided from the switching circuit part 258.

The upper electrode 759 has a horizontally patterned band-shape, and defines lighting areas. A first side portion of the upper electrode 759 is electrically connected to the first antenna electrode part 760. A second side portion of the upper electrode 659 is electrically connected to the second antenna electrode part 770.

The first antenna electrode part 760 includes a plurality of first antenna electrodes. The first antenna electrode part 760 is disposed at the first edge portion of the flat discharge tube 751 and applies electric power provided from the power level control part 256 to a first side portion of the upper electrode 759. Each of the first antenna electrodes of the first antenna electrode part 760 has a coil-shape. The first antenna electrodes are disposed in a first side area of the flat discharge tube 751. The first antenna electrodes are spaced apart from each other.

The second antenna electrode part 770 includes a plurality of second antenna electrodes. The second antenna electrode part 770 is disposed in a second side portion of the flat discharge tube 751 and applies power from the power level control part 256 to the second side portion of the upper electrode 759. Each of the second antenna electrodes has a coil-shape. The second antenna electrodes are spaced apart from each other.

### Embodiment 6 of a Surface Light Source Device

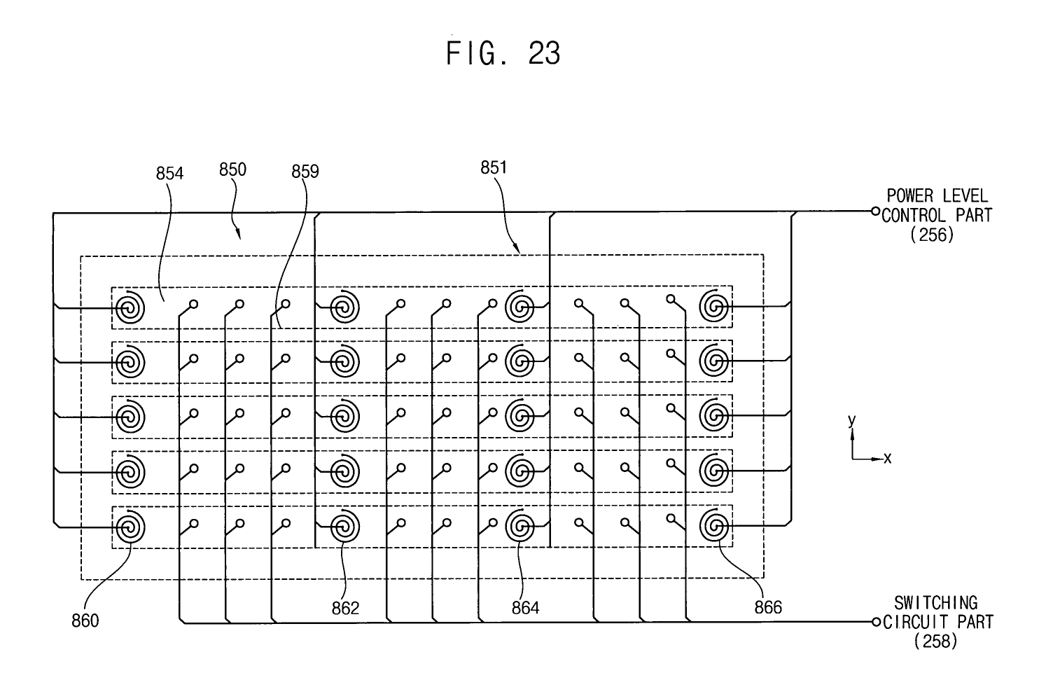

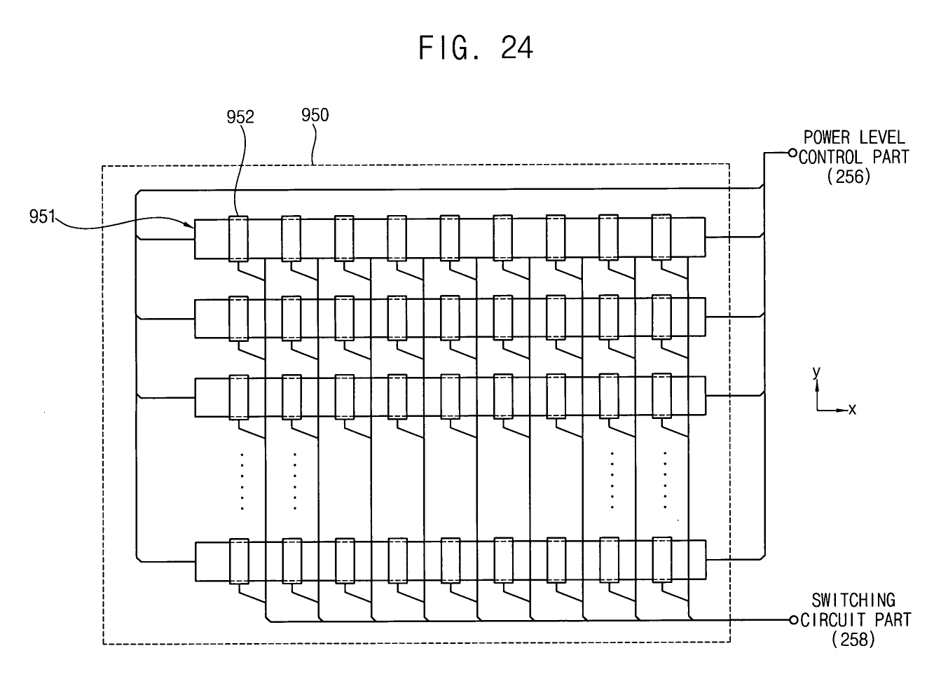

FIG. 23 is a cross-sectional view illustrating still another exemplary embodiment of a surface light source device according to the present invention. Particularly, FIG. 23 shows that a plurality of antenna electrodes is disposed in an exemplary unit discharge area.

Referring to FIG. 23, a surface light source device 850 includes a flat discharge tube 851, first, second, third, and fourth antenna electrode parts 860, 862, 864, and 866 respectively formed in first, second, third, and fourth areas of the flat discharge tube 851. The surface light source device 850 is applied to power controlled by each property of image signals and emits light.

The flat discharge tube 851 includes an upper substrate, a lower substrate facing the upper substrate, an upper electrode 859 formed on the upper substrate and a lower electrode 854 formed in the lighting areas of the lower substrate. The upper electrode 859 defines the lighting areas.

The flat discharge tube 851 emits light, when the flat discharge tube 851 receives electric power separately applied to each lighting area from the first, second, third, and fourth antenna electrode parts 860, 862, 864, and 866 in response to turning on or off signals from the switching circuit part 258. The upper electrode 859 has a horizontally patterned band-shape and defines lighting areas.

A first area of the upper electrode 859 is electrically connected to the first antenna electrode part 860. A second area of the upper electrode 859 is electrically connected to the second antenna electrode part 862. A third area of the upper electrode 859 is electrically connected to the third antenna electrode part 864. A fourth area of the upper electrode 859 is electrically connected to the fourth antenna electrode part 866. The first area is adjacent a first side of the flat discharge tube 851, the second area is between the first area and the third area, the third area is between the second area and the fourth area, and the fourth area is adjacent the third area and adjacent a second side of the flat discharge tube 851.

The first antenna electrode part 860 includes a plurality of first antenna electrodes. The first antenna electrode part 860 is disposed in a first area of the flat discharge tube 851 and applies electric powers provided from the power level control part 256 to a first area of the upper electrode 859. Each of the first antenna electrodes has a coil-shape and is disposed in a first area of the flat discharge tube 851. The first antenna electrodes are spaced apart from each other.

The second antenna electrode part 862 includes a plurality of second antenna electrodes. The second antenna electrode part 862 is disposed in a second area of the flat discharge tube 851 and applies electric powers provided from the power level control part 256 to a second area of the upper electrode 859. Each of the second antenna electrodes has a coil-shape and is disposed in a second area of the flat discharge tube 851. The second antenna electrodes are spaced apart from each other.

The third antenna electrode part 864 includes a plurality of third antenna electrodes. The third antenna electrode part 864 is disposed in a third area of the flat discharge tube 851 and applies power from the power level control part 256 to a third area of the upper electrode 859. Each of the third antenna electrodes has a coil-shape and is disposed in a third area of the flat discharge tube 851. The third antenna electrodes are spaced apart from each other.

The fourth antenna electrode part 866 includes a plurality of fourth antenna electrodes. The fourth antenna electrode part 866 is disposed in a fourth area of the flat discharge tube 851 and applies power from the power level control part 256 to a fourth area of the upper electrode 859. Each of the fourth antenna electrodes has a coil-shape and is disposed in a fourth area of the flat discharge tube 851. The fourth antenna electrodes are spaced apart from each other.

### Embodiment 7 of a Surface Light Source Device

FIG. 24 is a plan view illustrating an exemplary embodiment of a surface light source device according to the present invention. Particularly, FIG. 24 shows a plurality of cylindrical shaped discharge tubes parallelly disposed and formed with respect to a surface light source.

Referring to FIG. 24, a surface light source device 950 includes a plurality of cylindrical shaped discharge tubes 951 and a brightness control part 952 formed in each of the cylindrical shaped discharge tubes 951. The surface light source device 950 emits light, when the surface light source device 950 receives electric powers controlled in accordance with property of image signals.

The cylindrical shaped discharge tubes 951 are disposed on the same plane and are arranged in parallel with each other. Both end portions of the cylindrical shaped discharge tubes 951 are electrically connected to a power level control part 256. The cylindrical shaped discharge tubes 951 emit light when the cylindrical shaped discharge tubes 951 receive electric powers controlled by property of image signals.

The brightness control parts 952 include a transparent electrode covering an exterior of the cylindrical shaped discharge tubes 951. The transparent electrode is disposed at a uniform interval.

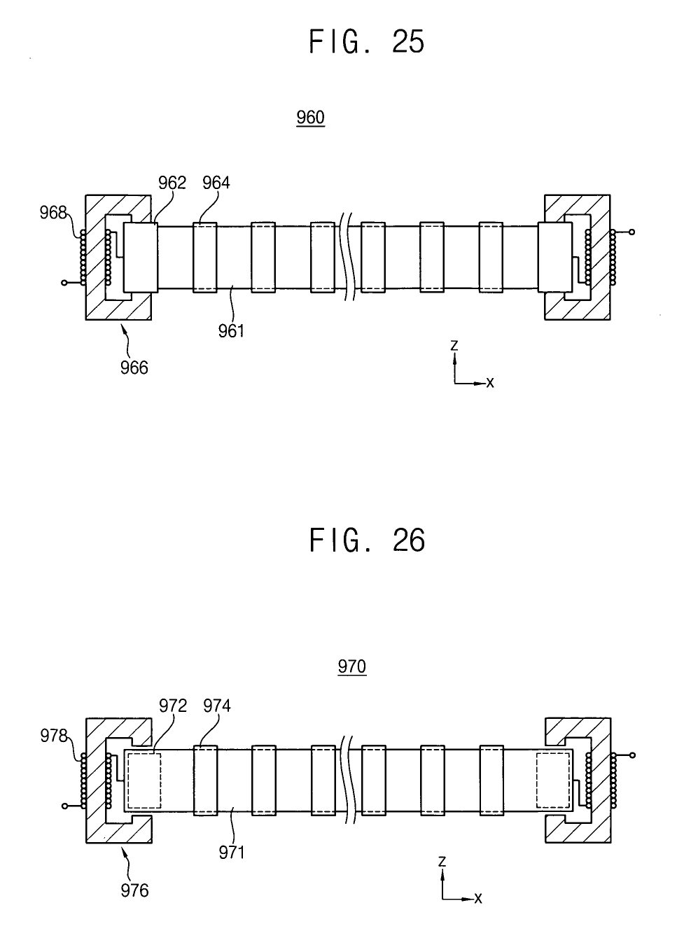

The cylindrical shaped discharge tubes 951 may be an external electrode fluorescent lamp (“EEFL”) having an external lamp as shown in FIG. 25 or a cold cathode fluorescent lamp (“CCFL”) having an internal lamp as shown in FIG. 26, both as will be further described below.

### Embodiment 8 of a Surface Light Source Device

FIG. 25 is a cross-sectional view illustrating still another exemplary embodiment of a surface light source device according to the present invention.

Referring to FIG. 25, a surface light source device 960 includes cylindrical shaped discharge tubes 961, an external electrode 962 covering an end portion of the cylindrical shaped discharge tubes 961 and a transparent electrode 964 covering a portion of the discharge tubes 961. A ferrite core 966 is disposed at a side portion of the cylindrical shaped discharge tubes 961. A coil 968 having a predetermined winding number is disposed in the ferrite core 966. One end portion of the coil 968 is electrically connected to the external electrode 962 and the other end portion of the coil 968 is electrically connected to the power supply part, or the power level control part.

### Embodiment 9 of a Surface Light Source Device

FIG. 26 is a cross-sectional view illustrating still another exemplary embodiment of a surface light source device according to the present invention.

Referring to FIG. 26 a surface light source device 970 includes cylindrical shaped discharge tubes 971, an internal electrode 972 formed in each of the cylindrical shaped discharge tubes 971 and a transparent electrode 974 covering a portion of the discharge tubes 971. A ferrite core 976 is disposed at an end portion of the cylindrical shaped discharge tube 971. A coil 978 having a predetermined winding number is disposed at the ferrite core 976. One end portion of the coil 978 is electrically connected to the internal electrode 972. The other end portion of the coil 978 is electrically connected to the power supply part, or the power level control part.

As explained above, according to the present invention, the surface light source partially controls brightness thereof. In detail, a first portion of the surface light source is relatively bright and a second portion of the surface light source is relatively dark, based on property of image. As a result, high contrast is obtained and power consumption is efficiently decreased.

### Embodiment 3 of a Display Device

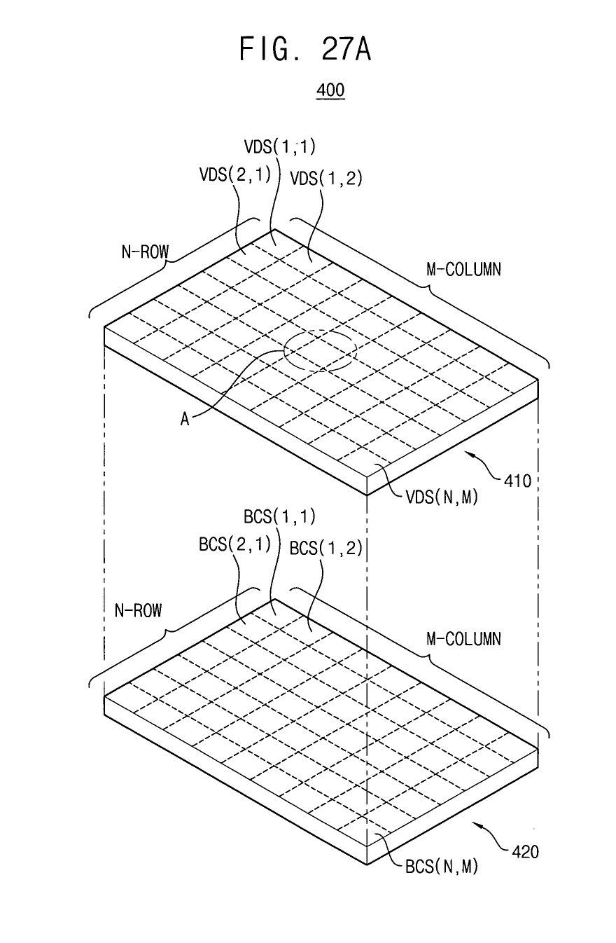

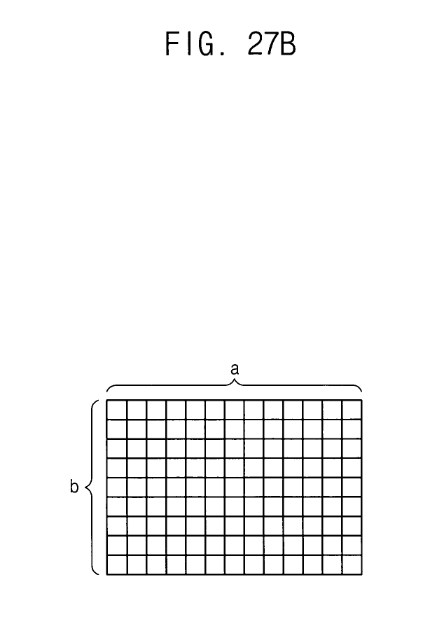

FIG. 27A is an exploded perspective view illustrating still another exemplary embodiment of a display device according to the present invention. Particularly, FIG. 27A shows a concept of partial controlling.

Referring to FIG. 27A and FIG. 27B, a flat display device 400 includes a liquid crystal panel 410 and a backlight unit 420 disposed on the backside of the liquid crystal panel 410. Although not illustrated for clarity, a diffusion plate or a prism sheet may be optionally disposed between the liquid crystal panel 410 and the backlight unit 420.

The backlight unit 420 has a plurality of a brightness control sections (“BCSs”) arranged in a matrix-shape. For example, the BCSs are arranged along M-column (or M-row) and N-row (or N-column). The BCSs respond to brightness properties of each image displayed on a plurality of video display sections (“VDSs”) of the liquid crystal panel 410. As a result, brightness is separately controlled.

Each of the VDSs corresponds to a BCS of the backlight unit 420, such as in a one by one correlation. A size of a VDS is decided by a surface area of a BCS. In other words, when a size of light exited from one BCS to the liquid crystal panel 410 is a×b (wherein ‘a’ denotes a number of horizontal pixels, ‘b’ denotes a number of vertical pixels, and ‘a’ and ‘b’ are natural numbers greater than 1), a size of one VDS is also a×b.

As described above, the liquid crystal panel 410 is virtually divided into regions on a plane corresponding to the BCSs of the backlight unit 420.

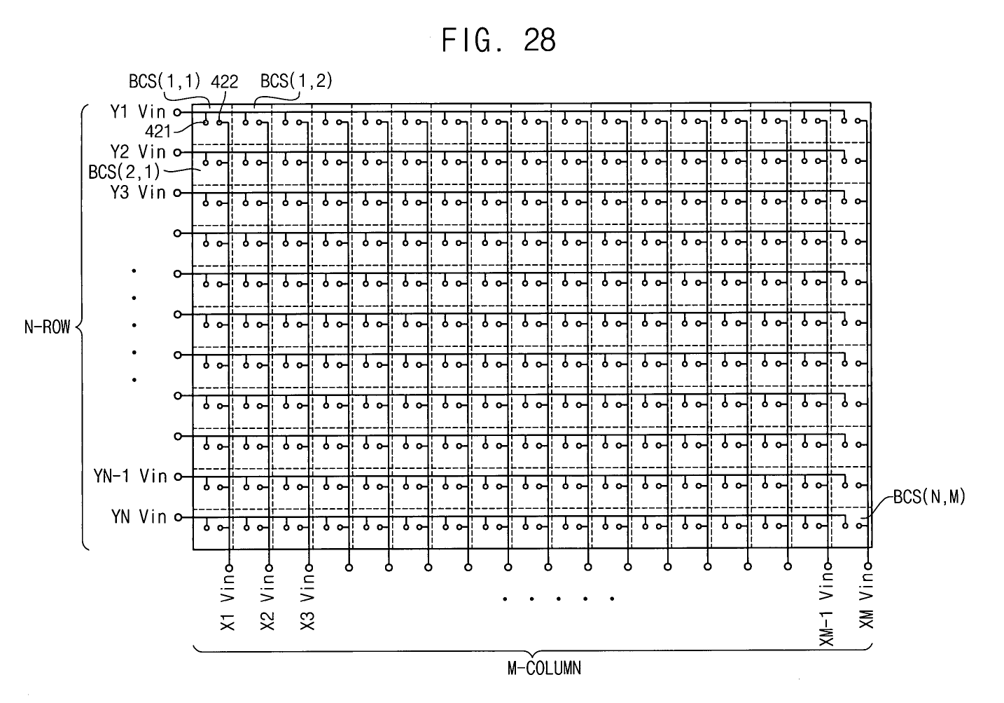

FIG. 28 is a plan view illustrating an exemplary arrangement of electrodes of the exemplary backlight unit in FIG. 27.

Referring to FIG. 28, a backlight unit 420 includes a flat fluorescent lamp having a plurality of discharge electrodes arranged in a matrix-shape. The flat fluorescent lamp includes at least a pair of first and second discharge electrodes 421 and 422 in each BCS.

For example, the first discharge electrodes 421 in a same column are electrically connected to each other, and the second discharge electrodes 422 in a same row are electrically connected to each other. As a result, the discharge electrodes define an electric connection structure of a matrix-shape.

Hereinafter, plane division sections of the liquid crystal panel 410 and the backlight unit 420, or the VDS and the BCS, each row (horizontal division) represented by ‘Yn’, each column (vertical division) is represented by ‘Xm’, wherein n, m, N, and M are natural numbers satisfying the conditions 1≦n≦N and 1≦m≦M.

In this present embodiment, the backlight unit 420 employs a flat fluorescent lamp as an example. However, the backlight unit 420 may employ other light emitting sources including, for example, a plurality of light emitting diodes (“LEDs”).

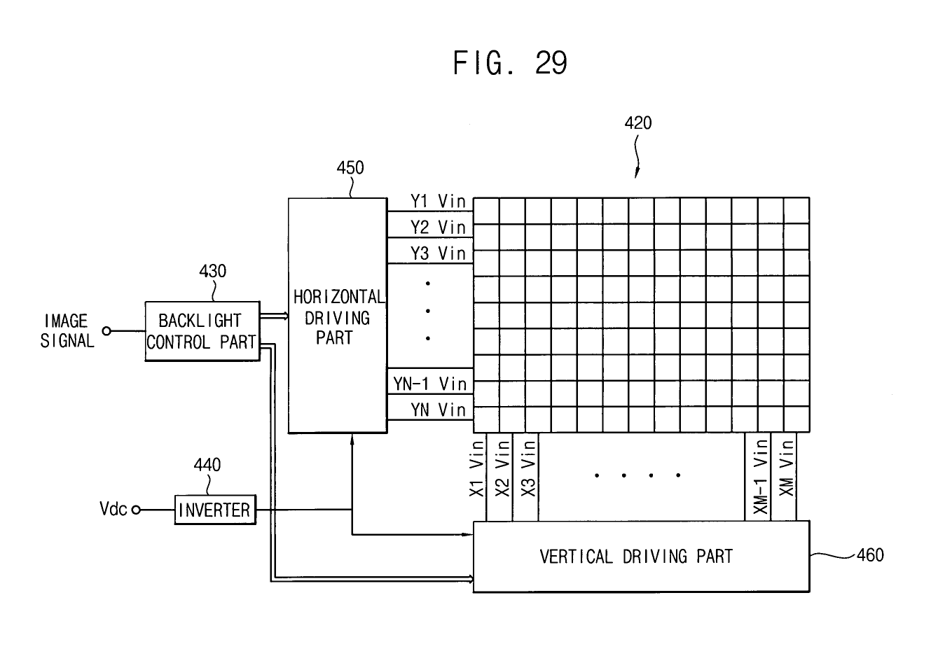

FIG. 29 is a block diagram illustrating an exemplary driving circuit format of the exemplary backlight unit in FIG. 28.

Referring to FIG. 29, a driving circuit of a backlight unit 420 includes a backlight control part 430, an inverter 440, a horizontal driving part 450, and a vertical driving part 460.

The backlight control part 430 receives an image signal from an external image signal source (not shown). The external image signal source, for example, provides computer video signals from a video controller of a computer system or television video signals from a television broadcasting receiver. The external image signal source outputs image signals including video signals, and horizontal and vertical signals. Image signals from the external image signal source are applied to the liquid crystal driving circuit (not shown). As a result, a driving of a conventional liquid crystal panel 410 is controlled.

The backlight control part 430 detects luminance signals, and horizontal and vertical signals from the received image signals. The backlight control part 430 also detects a maximum luminance value by comparing luminance values of all pixels in each VDS.

The backlight control part 430 drives the horizontal driving part 450 and vertical driving part 460, based on the detected maximum luminance value. The images are displayed on the VDSs, and the backlight control part 430 drives the BCSs of the backlight unit 420 separately at the same time. As a result, a luminance of each BCS is separately controlled.

The inverter 440 transforms direct current voltage Vdc from an external device into alternating current voltage Vac, and the inverter 440 applies the Vac to discharge electrodes of the backlight unit 420 through the horizontal driving part 450 and the vertical driving part 460. The structure and operation of the backlight unit 420 will be further described below.

Each of the horizontal driving part 450 and the vertical driving part 460 controls total electric power applied to discharge electrodes of the backlight unit 420 by pulse width modulation in response to control signals from the backlight control part 430.

The horizontal driving part 450 applies N number of alternating current voltage (Y1 Vin, Y2 Vin . . . , YN-1 Vin and YN Vin) corresponding to lines from a first line or row (Y1) to an N line or row (YN) and the vertical driving part 460 applies M number of alternating current voltage (X1 Vin, X2 Vin . . . , XM-1 Vin, and XM Vin) corresponding to columns from a first column (X1) to an M column (XM).

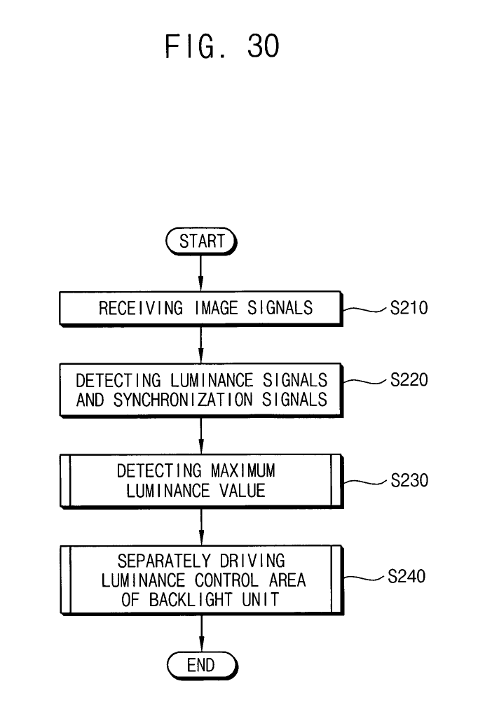

FIG. 30 is a flow chart showing an exemplary operation of the exemplary driving circuit of the backlight unit in FIG. 29.

Referring to FIGS. 29 and 30, a backlight control part 430 receives image signals from an external source, as shown by step S210. The image signals include video signals having luminance signals, and horizontal and vertical sync signals.

Subsequently, the backlight control part 430 detects luminance signals and synchronization signals, as shown by step S220. The backlight control part 430 detects a maximum luminance value, as shown by step S230.

The backlight control part 430 then separately drives luminance control areas of a backlight unit, based on the maximum luminance value to each BCS, as shown by step S240.

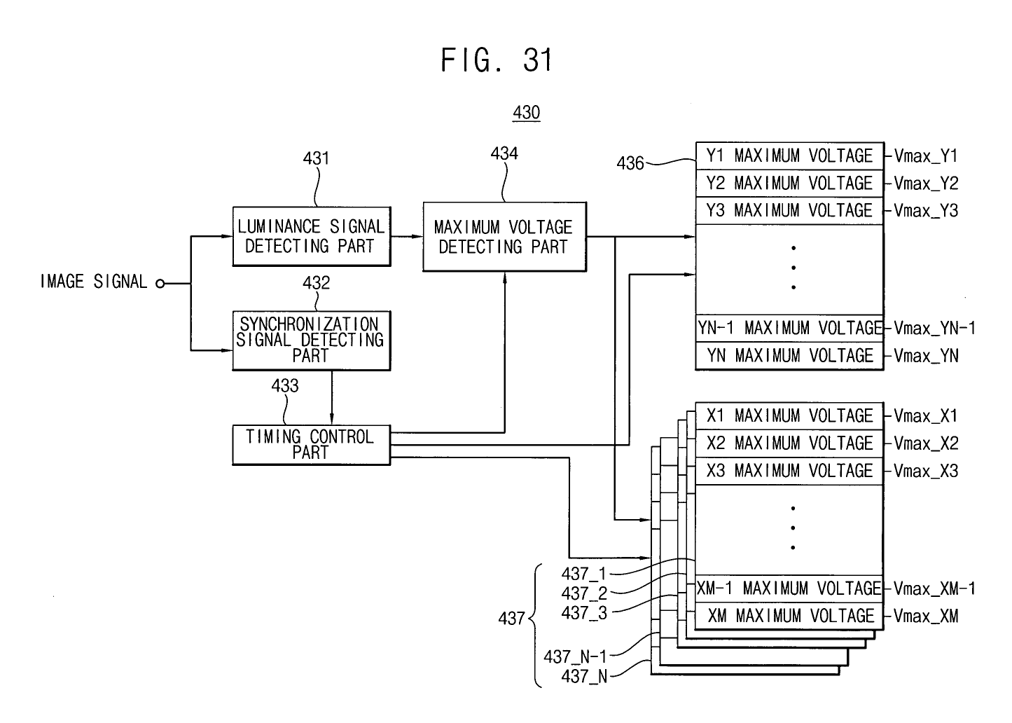

FIG. 31 is a block diagram illustrating a backlight control part in FIG. 29.

Referring to FIGS. 29 and 31, the backlight control part 430 includes a luminance signal detecting part 431, a synchronization signal detecting part 432, a timing control part 433, a maximum voltage detecting part 434, a first register 436, and a second register 437. For convenience, the backlight control part 430 is divided by a logic viewpoint, rather than by a hardware viewpoint. For example, a micom or Digital Signal Processor (“DSP”) may be employed as the backlight control part 430.

The luminance signal detecting part 431 detects a luminance signal from image signals from an external source and applies the detected signal to the maximum voltage detecting part 434. The luminance signal detecting part 431 may be a low pass filter (“LPF”). When an image signal is applied to the LPF, the LPF blocks high frequency signals having color signal components and transmits low frequency signals having luminance signal components.

The synchronization signal detecting part 432 detects horizontal and vertical signals from the image signals from the external source and applies the horizontal and vertical detected signals to the timing control part 433.

The timing control part 433 generates first, second, and third timing control signals for a plurality of portions of the backlight control part 430, based on the horizontal and vertical detected signals from the synchronization signal detecting part 432.

A first timing control signal from the timing control part 433 is applied to the maximum voltage detecting part 434. Subsequently, luminance signals from the luminance signal detecting part 431 are applied to the maximum voltage detecting part 434. As a result, the maximum voltage detecting part 434 detects a maximum voltage to each horizontal part (Y1˜YN), and a maximum voltage to each vertical area (X1˜XM) corresponding to each horizontal part (Y1˜YN). The detected maximum voltages are orderly stored in the first and second registers 436 and 437.

A second timing control signal from the timing control part 433 is applied to the first register 436. Then, the first register 436 stores a maximum voltage value Vmax of N-number of horizontal parts (Y1˜YN).

A third timing control signal from the timing control part 433 is applied to the second register 437. Then, the second register 437 stores a maximum voltage value Vmax of M numbers of vertical areas (X1˜XM) corresponding to each of the horizontal parts (Y1˜YN). The second register 437 includes N— number of sub registers (437_1, 437_2 . . . , 437_N˜1, and 437_N). A maximum value Vmax to each of the vertical areas (X1˜XM) is stored in each sub register (437_1, 437 2, . . . , 437_N˜1, and 437_N).

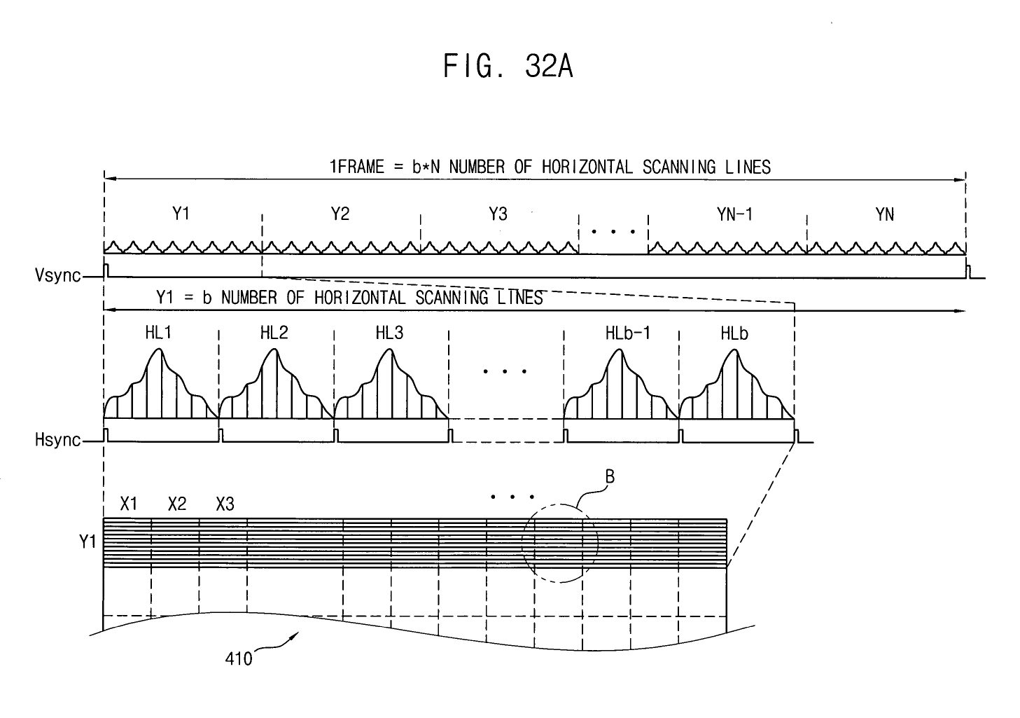

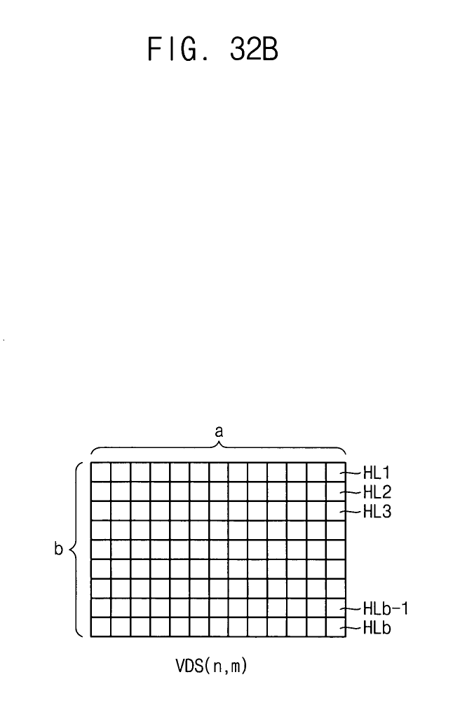

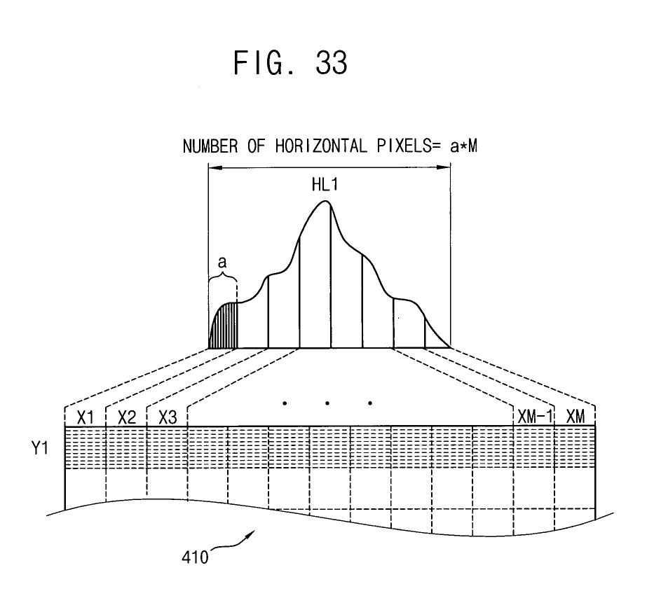

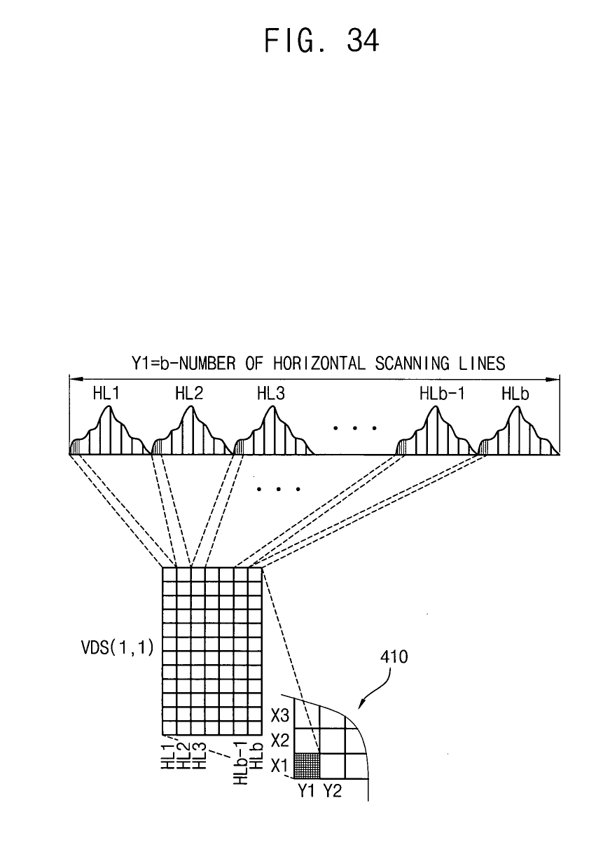

FIG. 32A is a conceptual view illustrating a process of dividing image signals of one frame into horizontal sections. FIG. 32B is an enlarged view illustrating portion ‘B’ in FIG. 32A. FIG. 33 is a conceptual view illustrating a process of dividing one horizontal scanning line into vertical sections. FIG. 34 is a conceptual view illustrating a process of dividing a plurality of horizontal scanning lines forming one horizontal section into vertical sections.

Referring to FIGS. 32A and 32B, an image signal from an image signal source has a certain horizontal scanning line to one frame. For example, according to an NTSC method (television standard named for the National Television System Committee), television image signals have five hundred and twenty five (or 525) horizontal scanning lines per one frame, and seven hundred (or 700) units of horizontal pixels are displayed in one scanning line. However, effective horizontal scanning lines are about four hundred and ninety three (or 493) and effective horizontal pixels are about six hundred and fifty eight (or 658).

When a number of pixels in one VDS formed in a liquid crystal panel such as liquid crystal panel 410 is a×b (‘a’ is a number of horizontal pixels, ‘b’ is a number of vertical pixels, ‘a’ and ‘b’ are natural numbers larger than one.), a and b may be represented as the following Expressions 1 and 2.
a=a number of horizontal pixels÷a number of vertical division parts M. Expression 1
b=a number of horizontal scanning lines÷a number of horizontal division parts N. Expression 2

Referring to FIG. 33, a number of horizontal pixels in one horizontal scanning line is a×M. The number of a×M may be divided into luminance signals corresponding to a number of pixels in each of the vertical areas (X1˜XM).

In the same manner as above, luminance signals corresponding to b number of horizontal scanning lines (HL1˜HLb) may be divided into each of the vertical areas (X1˜XM) as shown FIG. 34.

Referring back to FIG. 31, the maximum voltage detecting part 434 compares all luminance of pixels in b-number of horizontal scanning lines in one horizontal area to detect a maximum luminance value to each horizontal area.

The maximum voltage detecting part 434 divides horizontal areas into vertical areas again and detects a maximum luminance value for each vertical area. A detection of the maximum luminance value is obtained by detecting a maximum value of voltage levels of luminance signals.

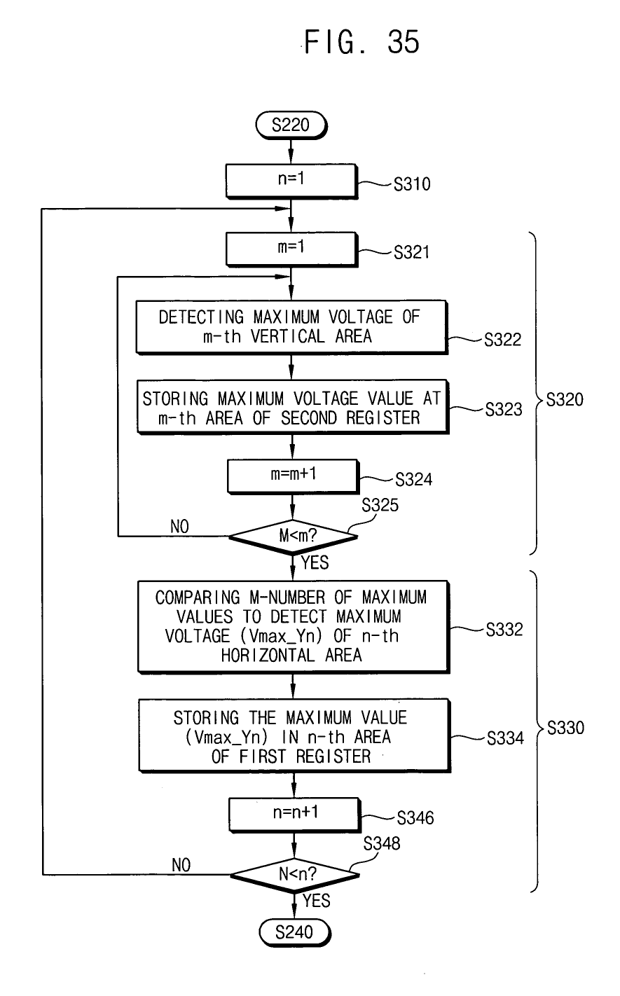

FIG. 35 is a flow chart illustrating stages detecting a maximum luminance value of each image display section.

Referring to FIGS. 30 to 35, the step of detecting luminance signals and synchronization signals demonstrated by step S220 as part of an operation of a driving circuit of a backlight shown in FIG. 30, follows as shown in FIG. 35. The maximum voltage detecting part 434 initializes a first register 436 and a second register 437, and initializes a first variable ‘n’ to one as shown by step S310.

Subsequently, the maximum voltage detecting part 434 begins a process for detecting a maximum voltage value to each vertical area (X1˜XM) in an n-th horizontal area as shown by step S320.

As part of step S320, the maximum voltage detecting part 434 initializes a second variable ‘m’ to be one as shown in step S321, and detects a maximum voltage of an m-th vertical area (Xm) included in the n-th horizontal area (Yn) as shown in step S322. The maximum voltage detecting part 434 stores a maximum voltage value (Vmax_Xm) detected from the step S322 into the m-th area of the second register 437 as shown by step S323.

Subsequently, the maximum voltage detecting part 434 increases a second variable ‘m’ by one as shown in step S324, and checks if M<m in order to assure that the maximum value of the last vertical area in an n-th horizontal area is obtained as shown in step S325. In step S325, when the condition of M<m is not satisfied, the maximum voltage detecting part 434 gets fed back to step S322 to detect all maximum values (Vmax_X1˜Vmax_XM) to M-number of vertical areas and orderly stores maximum values (Vmax_X1˜Vmax_XM) in a second register 437. In other words, steps S322, S323, and S324 are repeated.

In step S325, when the condition of M<m is satisfied, the maximum voltage detecting part 434 begins a process that detects a maximum value to an n-th horizontal area as shown by step S330.

As part of step S330, the maximum voltage detecting part 434 compares M-number of maximum voltage values with each other and detects a maximum voltage (Vmax_Yn) of an n-th horizontal area (Yn) as shown in step S332. Subsequently, the maximum voltage detecting part 434 stores a maximum voltage (Vmax_Yn) of a detected n-th horizontal area (Yn) in an n-th area of the first register 436 as shown in step S334.

Subsequently, the maximum voltage detecting part 434 increases a first variable ‘n’ by one as shown by step S346, and checks if N<n in order to assure that a maximum value of the last horizontal area is obtained as shown in step S348. In step S348, when the condition of N<n is not satisfied, the maximum voltage detecting part 434 gets fed back to the step S321 to detect all maximum values (Vmax_Y1˜Vmax_YM) to N-number of horizontal areas and orderly stores them in a first register 436. In the step S348, when the condition of N<n is satisfied, the maximum voltage detecting part 434 finishes a process.

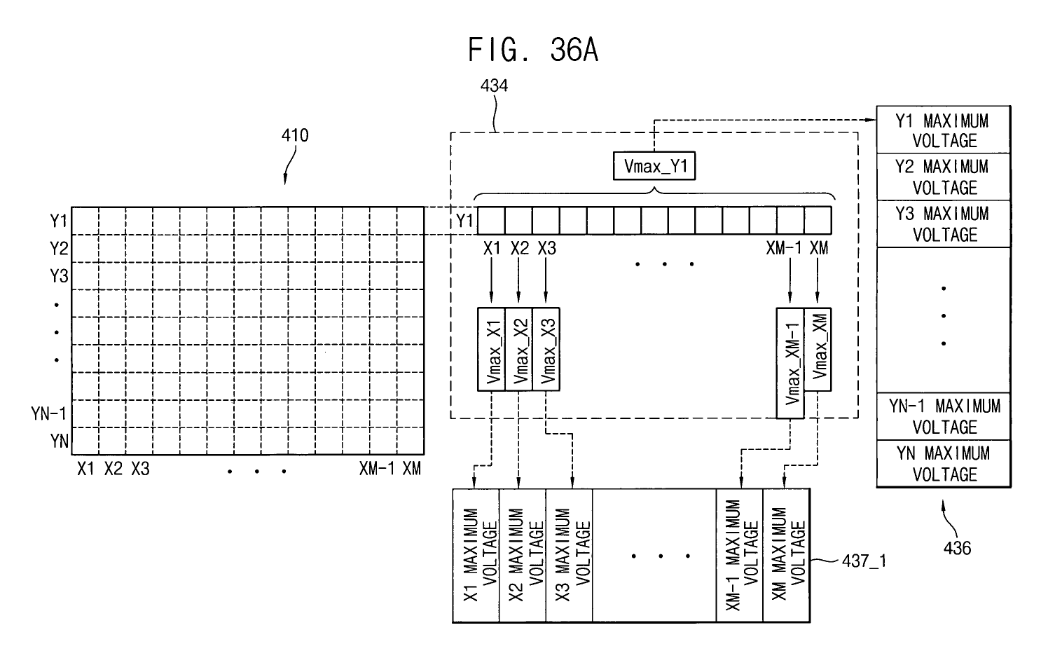

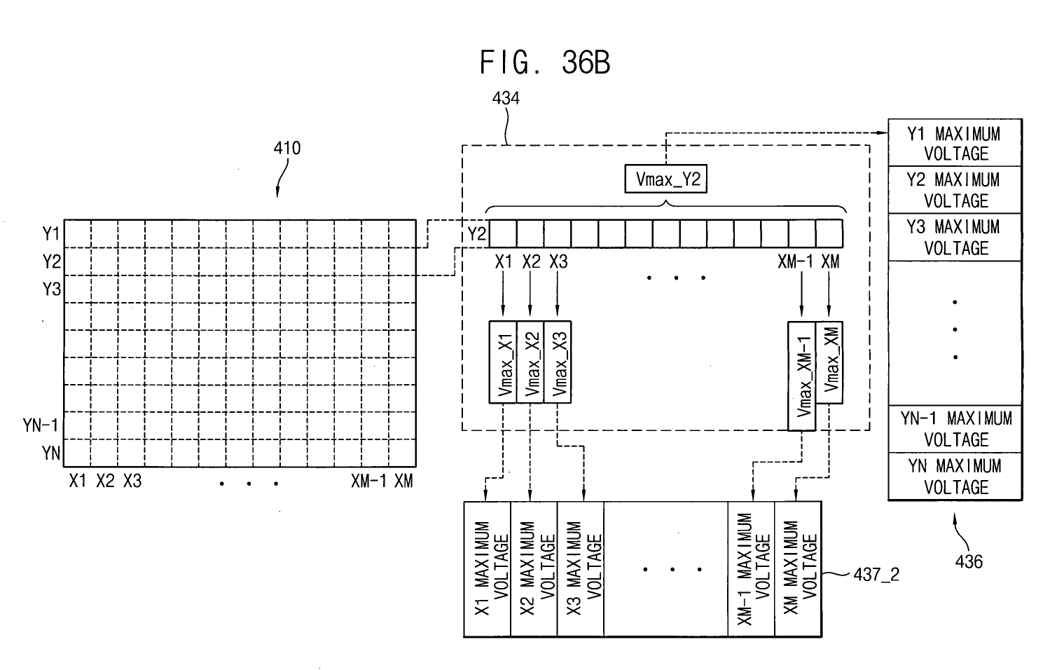

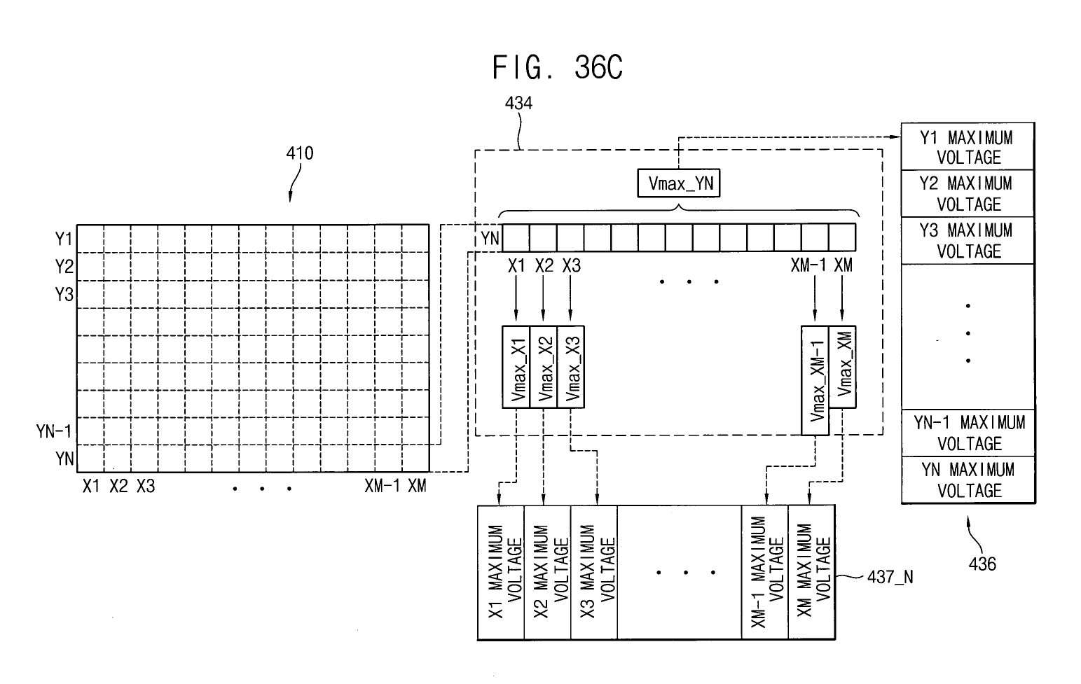

FIGS. 36A to 36C are conceptual views showing a process of detecting maximum voltage about horizontal and vertical sections.

A maximum voltage (Vmax_Y1) of a first horizontal area detected in a first horizontal area is stored in a first register 436 as shown FIG. 31 and FIG. 36A. M-numbers of maximum voltages (Vmax_X1˜VmaxXM) detected in M number of vertical areas (X1˜XM), which are included in the first horizontal area (Y1), are orderly stored in a second register 437_1.

Subsequently, as shown FIG. 30 and FIG. 36B, a maximum voltage (Vmax_Y2) of a second horizontal area detected in a second horizontal area is stored in a first register 436. M-numbers of maximum voltages (Vmax_X1˜VmaxXM) detected in M number of vertical areas (X1˜XM), which are included in the second horizontal area (Y2), are orderly stored in a second register 437_2.

In the same manner as above, the maximum voltage detecting part 434 detects a maximum voltage of each horizontal and vertical area from a first area (Y1) to an n-th area (YN), and the detected maximum voltage value is stored in a first register 436 and a second register 437_N as shown FIG. 36C.

A method of detecting a maximum voltage to each horizontal and vertical area may include a detailed process of an orderly scanning method, an interlaced scanning method, a plane-division scanning method, etc.

Hereinafter, a controlling process about a horizontal driving part 450 and a vertical driving part 460 as previously described with respect to FIG. 29, controlled by a backlight control part 430 will be described, and a process of driving a backlight unit 420 by a horizontal driving part 450 and a vertical driving part 460 will also be described.

As described above, a maximum voltage value of each horizontal area (Y1˜YN) is stored in a first register 436 and a maximum voltage value of each vertical area (X1˜XN) is stored in a second register 437. Maximum voltage values stored in a first register 436 and a second register 437 are orderly outputted by a control of the timing control part 433 of the backlight control part 430.

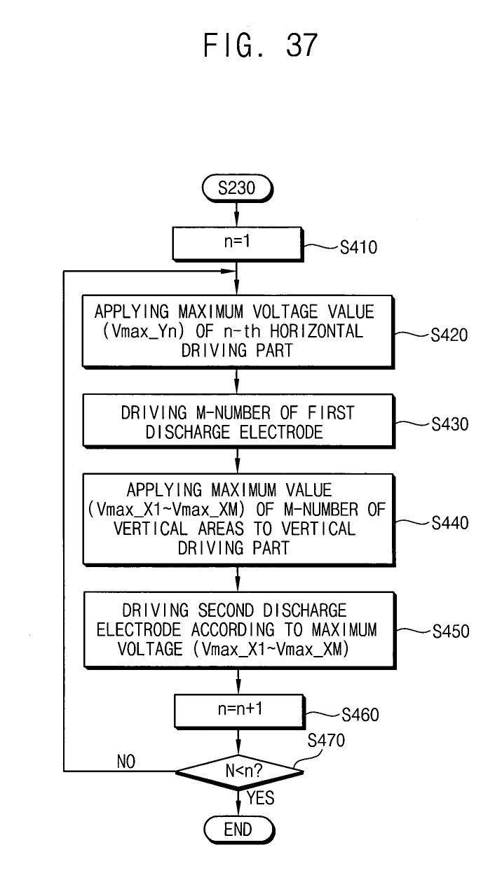

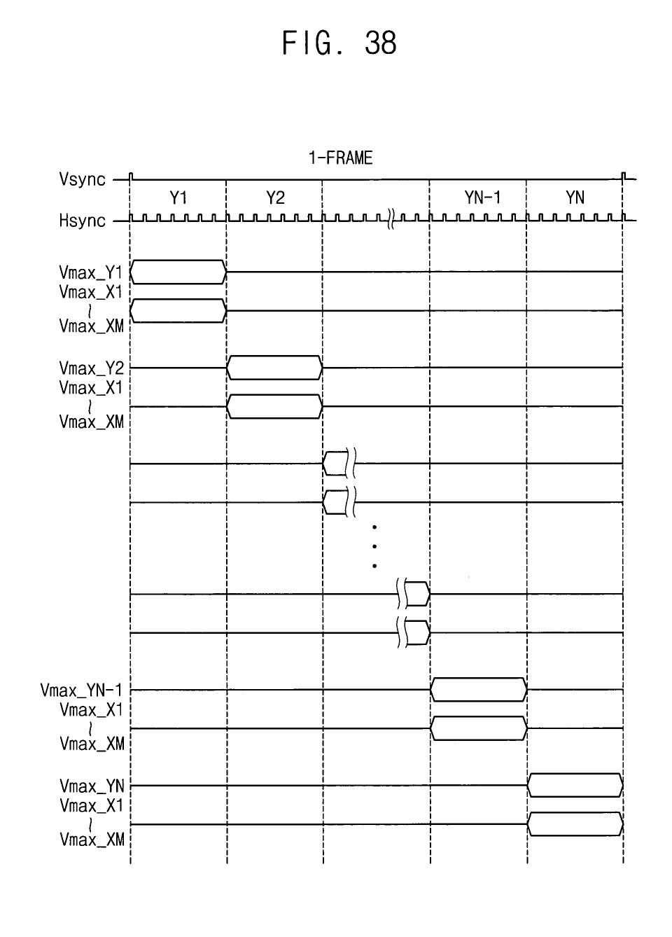

FIG. 37 is a flow chart showing a method of driving the exemplary backlight unit in FIG. 29. FIG. 38 is a timing diagram showing a maximum voltage value outputted from first and second registers of an exemplary backlight control part.

Referring to FIGS. 29, 37 and 38, a backlight control part 430 initializes a first variable ‘n’ to be one as shown by step S410. The backlight control part 430 applies a maximum voltage value (Vmax_Yn) of an n-th horizontal area (Yn), which is stored in the first register, to the horizontal driving part 450 as shown by step S420.

Subsequently, according to a maximum voltage (Ymax_Yn) of the horizontal driving part 450, the horizontal driving part 450 drives M-number of first discharge electrodes 421, as previously described with respect to FIG. 28, disposed in an n-th horizontal area (Yn) of the backlight unit 420 as shown by step S430. The first discharge electrode 421 is electrically connected to each other through each line (horizontal lines).

Subsequently, a backlight control part 430 applies a maximum value (Vmax_X1˜Vmax_XM) of M-number of vertical areas (X1˜XM) to the vertical driving part 460 as shown by step S440. The M number of vertical areas corresponds to the n-th horizontal area (Yn) from the second register 437.

Subsequently, when a maximum voltage (Vmax_X1˜Vmax_XM) is applied to the vertical driving part 460, the vertical driving part 460 drives M-number of second discharge electrodes 422, as previously described with respect to FIG. 28, disposed in an n-th horizontal area (Yn) of the backlight unit 420 as shown by step S450. The second discharge electrode 422 is electrically connected along each line (vertical lines).

Subsequently, the backlight control part 430 increases a first variable n by one as shown in step S460, and checks if an increased first variable is greater than N. In step S460, when the increased first variable is greater than N, the process is finished.

However, when the increased first variable is smaller than N or equals N, the backlight control part 430 gets fed back to the stage S420.

In this way, a maximum value (Vmax_Y1˜Vmax_YN) of each horizontal area (Y1˜YM) and a maximum value (Vmax_X1˜Vmax_XM) of each vertical area (X1˜XM) are applied to the vertical driving part 460 and the horizontal driving part 450 at the same time, when images corresponding to image signals of one frame are displayed in the liquid crystal panel 410.

Further, the vertical driving part 460 and the horizontal driving part 450 divide and drive first and second discharge electrodes 421, 422 disposed in BCS of the backlight unit 420, based on inputted maximum voltage values, respectively.

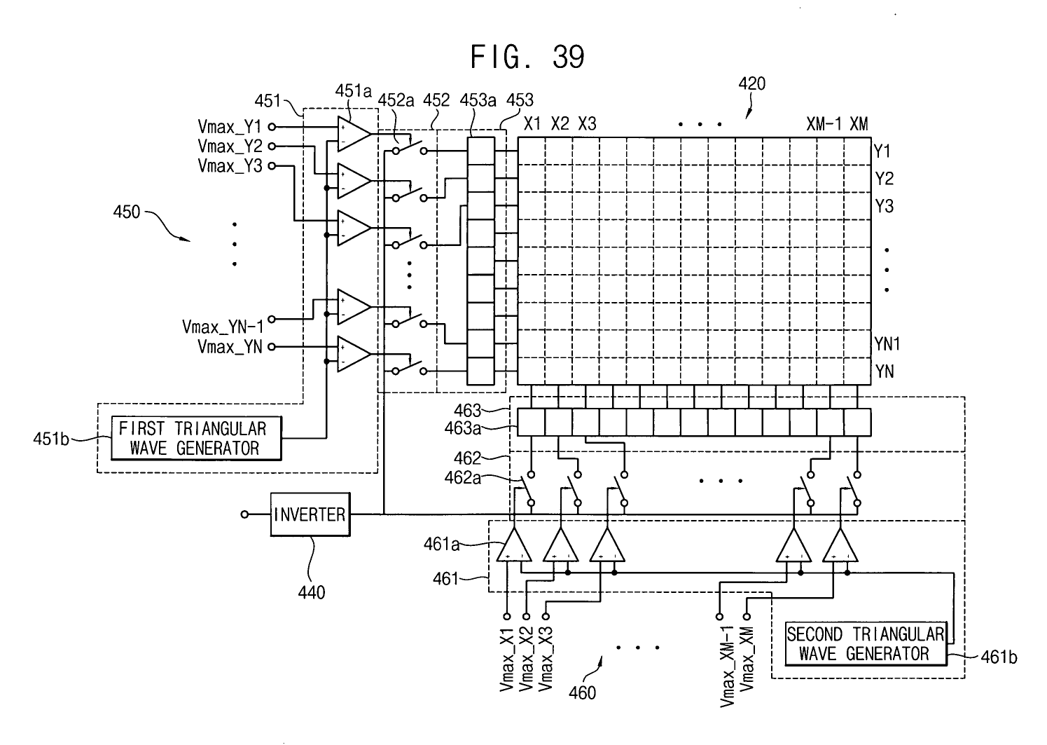

FIG. 39 is a circuit diagram illustrating an exemplary horizontal driving part and an exemplary vertical driving part in FIG. 29.

Referring to FIG. 39, a horizontal driving part 450 includes a first switching control circuit 451, a first switching circuit 452, and a first transforming circuit 453. The horizontal driving part 450 drives a first discharge electrode 421 (FIG. 28) disposed in each horizontal area according to a maximum value (Vmax_Y1, Vmax_Y2, . . . , Vmax_YN-1, and Vmax_YN).

The first switching control circuit 451 includes N-number of comparators 451a disposed in parallel and a first triangular wave generator 451b. A first input terminal and a second input terminal of the N-number of comparators 451a are separately connected to the first register 436 and the first triangular wave generator 451b.

The first switching circuit 452 includes N-number of switches 452a disposed in parallel. Input terminals of the switches 452a are electrically connected to inverter 440 in parallel with each other, and output terminals of the switches 452a are electrically connected to the first transforming circuit 453 in parallel with each other. Output terminals of the comparators 451a are electrically connected to switching terminals of the switches 452a. Each of the switches 452a may be a semiconductor switch such as a field effect transistor (“FET”) or bipolar junction transistor (“BJT”).

The first transforming circuit 453 includes N-number of transformers 453a disposed in parallel with each other. A first part of each transformer 453a is electrically connected to an output terminal of a switch 452a and a second part of each transformer 453a is electrically connected to a power input terminal (Y1_Vin˜YN_Vin) of each line, as previously described with respect to FIG. 28, formed in horizontal areas of the backlight unit 420.

The N-number of transformers 453a includes a step-up transformer having a first part and a second part of which winding ratio is one over K (1<K, K is a real number larger than one).

A vertical driving part 460 includes a second switching control circuit 461, a second switching circuit 462, and a second transforming circuit 463. The vertical driving part 460 has a substantially same circuit structure as that of the horizontal driving part 450. However, a number of comparators 461a, switches 462a, and transformers 463a formed in the second switching control circuit 461, the second switching circuit 462, and the second transforming circuit 463, respectively, is ‘M’, where ‘M’ corresponds to a number of vertical areas (X1˜XM).

A triangular wave generator 451b of the first switching control circuit 451 and a triangular wave generator 461b of the second switching control circuit 461 are separately formed. Alternatively, the first and second switching control circuits 451 and 461 may be integrated into one.

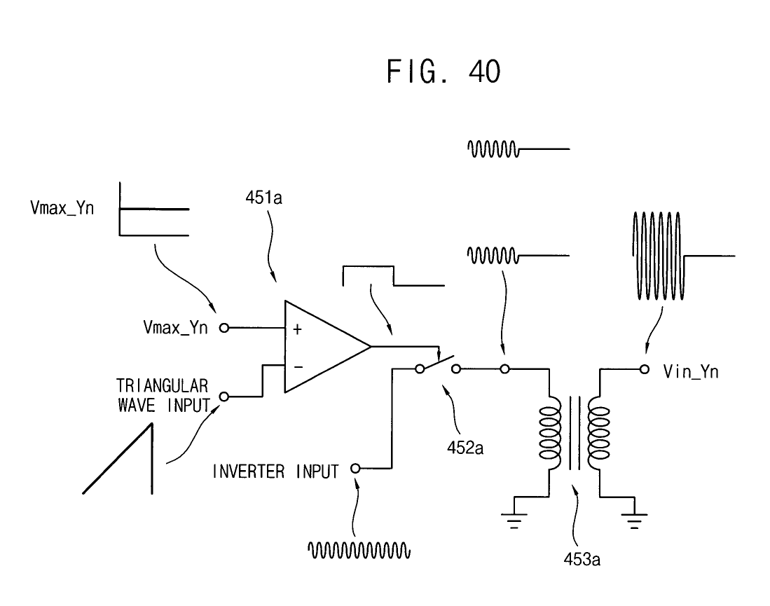

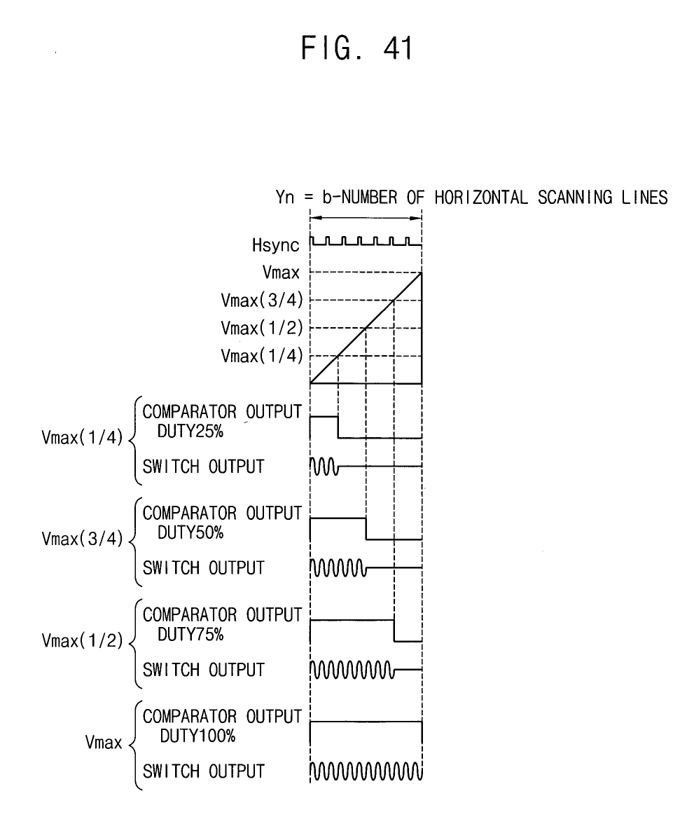

FIG. 40 is a conceptual view showing a waveform of each important node of a horizontal driving part. FIG. 41 is a waveform diagram showing a change of duty according to a change of a maximum voltage value of a horizontal section.

Referring to FIGS. 40 and 41, a maximum voltage value (Vmax_Yn) of an n-th horizontal area (Yn) of a horizontal driving part 450 is applied to an n-th comparator 451a of a first switching control part 451. The comparator 451a compares a voltage value of triangular wave, which corresponds to a reference voltage, with an inputted maximum voltage value (Vmax_Yn) to generate switching control signals that correspond to a square wave of which amplitude is modulated.

According to a maximum voltage level, duty of a switching control signal of square wave from the comparator 451a is changed. Frequency of triangular wave from the triangular wave generator is b times lower than that of horizontal synchronization signal (Hsync) of image signals.

The switch 452a is turned on or off in response to the switching control signal outputted from the comparator 451a, so that alternating currents provided from the inverter 440 are applied to the transformer 453a. The transformer 453a boosts up the alternating current.

While only waveforms of the main node of a horizontal driving part are explained, it should be understood that waveforms of the main node of a vertical driving part are substantially the same as that of the horizontal driving part.

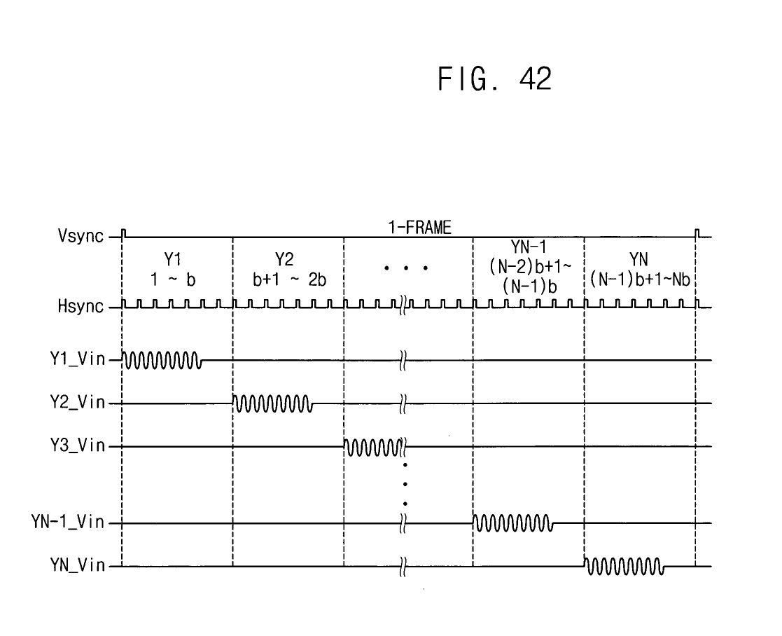

FIG. 42 is a timing diagram illustrating an operation of a horizontal driving part in FIG. 29.

Referring to FIGS. 29 and 42, when the horizontal driving part 450 receives N-number of maximum voltage values (Vmax_Y1˜Vmax_YN) in sequence from the backlight control part 430, the horizontal driving part 450 applies N-number of horizontal driving voltages (Y1_Vin˜YN_Vin) to a voltage input terminal of horizontal areas (Y1˜YN) of the backlight unit 420 in sequence.

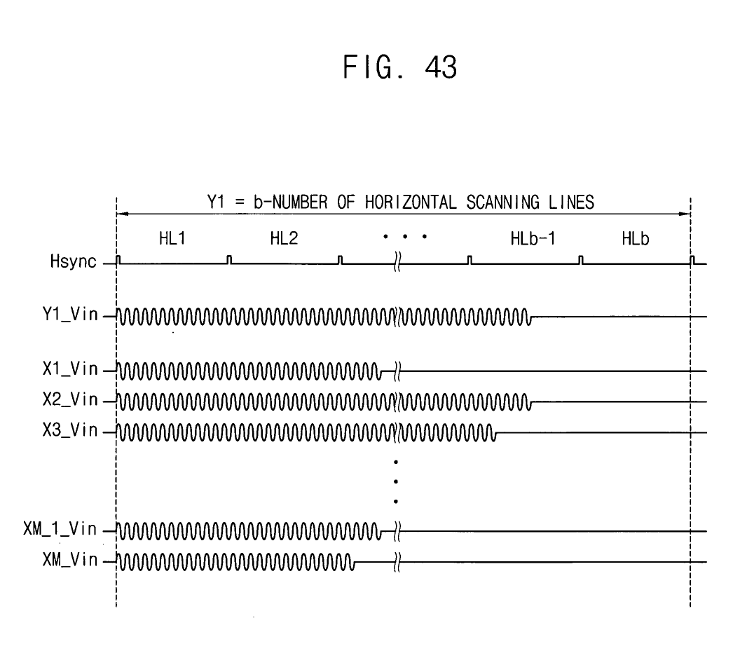

Meanwhile, referring to FIGS. 29 and 43, when the vertical driving part 460 receives M-number of maximum voltage values (Vmax_X1˜Vmax_XM) of each vertical area (X1˜XM) from the backlight control part 430, the vertical driving part 460 applies M-numbers of vertical driving voltages (X1_Vin˜XM_Vin) to a voltage input terminal of vertical areas (X1˜XM) of the backlight unit 420 at the same time.

As explained above, when the horizontal driving part 450 and the vertical driving part 460 operate, the first and second discharge electrodes 421, 422 disposed in each BCS of the backlight unit 420 are driven in sequence for the horizontal areas (Y1˜YN), and each of the vertical areas (X1˜XM) corresponding to each horizontal areas (Y1˜YN) is driven simultaneously.

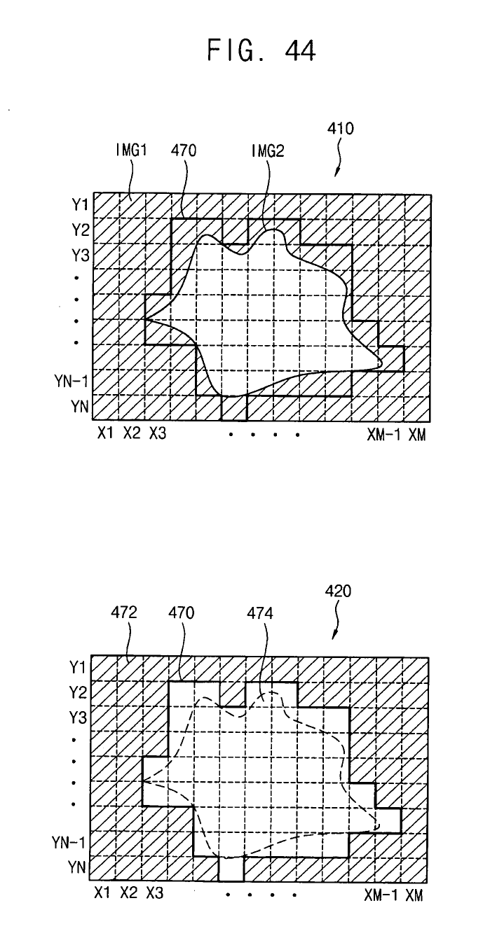

FIG. 44 is a conceptual view illustrating an example of controlling luminance performed by a luminance control part of an exemplary backlight unit as distribution of an image luminance displayed on an exemplary liquid crystal panel.

As shown in FIG. 44, images having, for example, two luminance levels are displayed on a liquid crystal panel 410. Particularly, images IMG2 of relatively high luminance are displayed on a center region of screen, and images IMG1 of relatively low luminance are displayed on a peripheral region of screen.

Then, a backlight unit 420 is driven such that the backlight unit 420 emits light having relatively higher luminance towards the center region on which images IMG2 of high luminance are displayed, and the backlight unit 420 emits light having relatively lower luminance in a region 472 located toward the peripheral region. A region 470 of the relatively high luminance has, for example, a bigger size than a size of the region 474 where the images IMG2 of high luminance occur.

As described above, the surface light source according to the present invention includes the upper substrate having the upper electrode formed thereon, and the lower substrate having the plurality lower substrates that are formed in the lighting areas of the lower substrate, the lighting areas defined by spacers. Therefore, the surface light source has a function of controlling brightness according to a specific part.

Further, when images displayed on display apparatus are partially dark or bright, by controlling brightness of a light source to be partially dark or bright according to the properties of the images, relatively high contrasts and relatively low power consumption are obtained.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A surface light source apparatus comprising:
a discharge tube including a plurality of lighting areas, each lighting area having a discharge electrode part;
a power source applying electric power to each discharge electrode part; and
a surface light source control part separately controlling brightness of each lighting area by separately controlling electric power levels applied to the discharge electrode part of each lighting area, respectively.

2. The surface light source apparatus of claim 1, wherein the surface light source control part controls the power levels applied to the discharge electrode part of each lighting area according to properties of an image signal.

3. The surface light source apparatus of claim 1, wherein the surface light source control part further comprises a light sensor part sensing ambient luminance, and the surface light source control part controls power levels applied to the discharge electrode part of each lighting area, based on detected level of the ambient luminance from the light sensing part.

4. The surface light source apparatus of claim 1, wherein the discharge electrode part of each lighting area includes first and second discharge electrodes facing each other, and the first and second discharge electrodes have a flat-shape structure.

5. The surface light source apparatus of claim 1, wherein the discharge electrode part of each lighting area has first and second discharge electrodes facing each other, and the first and second discharge electrodes have a flat-spiral-shape structure.

6. The surface light source apparatus of claim 1, wherein the surface light source control part comprises:
a power level control part applying power from an external source, responding to a signal controlling power level and a controlling power level applied to each discharge electrode part of the lighting areas; and
a backlight control part checking properties of image signals, and generating signal controlling power levels to control brightness of the lighting areas according to checked properties of image signals.

7. The surface light source apparatus of claim 6, wherein the discharge electrode part of each lighting area includes first and second discharge electrodes facing each other, and one of the first and second discharge electrodes is electrically connected to the power level control part.

8. The surface light source apparatus of claim 6, wherein the discharge electrode part of each lighting area includes first, second, third, and fourth discharge electrodes, disposed in a tetragonal shape, and at least two electrodes of the first, second, third, and fourth discharge electrodes are electrically connected to the power level control part.

9. The surface light source apparatus of claim 8, wherein a phase of a frequency of power applied to the first to fourth discharge electrodes is different than a phase of a frequency of power from that of neighboring electrodes.

10. The surface light source apparatus of claim 8, wherein a phase of a frequency of power applied to one of the first to fourth discharge electrodes is different than a phase of a frequency of power applied to another of the first to fourth discharge electrodes.

11. The surface light source apparatus of claim 1, wherein each lighting area in the plurality of lighting areas has a tetragonal-shape, a circular-shape, or a polygonal-shape.

12. A surface light source apparatus comprising:
a discharge tube;
an electromotive force generating part applying an inducted electromotive force inducting plasma discharge to the discharge tube;
a power source applying electric power to the electromotive force generating part;
a brightness control part uniformly arranged in the discharge tube, the brightness control part forming a plurality of unit brightness control areas and partially controlling brightness of the unit brightness control areas; and
a surface light source control part separately controlling brightness with respect to each unit brightness control area by controlling the brightness control part.

13. The surface light source apparatus of claim 12, wherein the surface light source control part separately controls brightness of each unit brightness control area according to properties of image signals.

14. The surface light source apparatus of claim 12, wherein the surface light source control part further comprises a light sensor part sensing ambient luminance and the surface light source control part controls brightness of each unit brightness control area based on detected light level from the light sensor part.

15. The surface light source apparatus of claim 12, wherein the surface light source control part comprises:
a switching circuit generating driving signals for driving the brightness control part according to brightness control signals; and
a backlight control part generating the brightness control signals for controlling brightness of each of the unit brightness control areas according to results of checked properties of image signals.

16. The surface light source apparatus of claim 12, further comprising a power level control part controlling power level of power from the power source applied to the electromotive force generating part.

17. The surface light source apparatus of claim 16, wherein the surface light source control part controls the power level control part to control power level of power from the power source applied to the electromotive force generating part according to properties of image signals from an image signal source.

18. The surface light source apparatus of claim 17, wherein the surface light source control part further includes a light sensor part for sensing ambient luminance, and the surface light source control part controls the power level control part for controlling power level of power from the power source applied to the electromotive force generating part based on a detected light level from the light sensor part.

19. The surface light source apparatus of claim 12, wherein the electromotive force generating part comprises:
a flat discharge electrode disposed at an edge portion of the discharge tube;
a ferrite core disposed at a side portion of the discharge tube; and
a coil wound around the ferrite core, wherein a first end portion of the coil is connected to the flat discharge electrode and a second end portion of the coil is connected to the power source.

20. The surface light source apparatus of claim 19, wherein the electromotive force generating part includes a first electromotive force generating part on a first side of the discharge tube and a second electromotive force generating part on a second side of the discharge tube, each of the first and second electromotive force generating parts having a flat discharge electrode, a ferrite core, and a coil.

21. The surface light source apparatus of claim 12, wherein the brightness control part includes a plurality of point electrodes uniformly distributed and disposed on a backside of the discharge tube.

22. The surface light source apparatus of claim 12, wherein the brightness control part comprises:
a ferrite core uniformly distributed and disposed on a backside of the discharge tube; and
a coil wound around the ferrite core.

23. The surface light source apparatus of claim 22, wherein the brightness control part comprises:
a plurality of magnets disposed on a backside of the discharge tube.

24. The surface light source apparatus of claim 12, wherein the discharge tube includes a plurality of dividing spacers providing a plurality of discharge areas within the discharge tube.

25. The surface light source apparatus of claim 24, wherein the electromotive force generating part includes a plurality of sub electromotive force generating parts corresponding to each of the discharge areas of the discharge tube, respectively, wherein the sub electromotive force generating parts totally or separately control power supply.

26. The surface light source apparatus of claim 24, wherein the electromotive force generating part includes flat-coil-shaped antenna electrodes disposed in a plurality of discharge areas of the discharge tube, respectively.

27. The surface light source apparatus of claim 26, wherein the electromotive force generating part includes a plurality of antenna electrode parts, each antenna electrode part including a plurality of the flat-coil-shaped antenna electrodes, the antenna electrode parts distributed evenly across the discharge tube.

28. The surface light source apparatus of claim 12, wherein the discharge tube includes a plurality of cylindrical shaped discharge tubes.

29. The surface light source apparatus of claim 28, wherein the brightness control part is at least one transparent electrode uniformly disposed with respect to each of the cylindrical shaped discharge tubes.

30. The surface light source apparatus of claim 29, comprising a plurality of transparent electrodes covering uniformly distributed portions of an exterior of each of the cylindrical shaped discharge tubes.

31. The surface light source apparatus of claim 28, further comprising:
an external electrode disposed at an external portion of the cylindrical shaped discharge tubes;
a ferrite core; and
a coil wound around the ferrite core, wherein one end portion of the coil is connected to the external electrode and another end portion of the coil is connected to the power source.

32. The surface light source apparatus of claim 31, wherein the cylindrical shaped discharge tubes are external electrode fluorescent lamps.

33. The surface light source apparatus of claim 28, further comprising:
an internal electrode disposed in each of the cylindrical shaped discharge tubes;
a ferrite core disposed at an external portion of the cylindrical shaped discharge tube; and
a coil wound around the ferrite core, wherein one end portion of the coil is connected to each internal electrode and another end portion of the coil is connected to the power source.

34. The surface light source apparatus of claim 33, wherein the cylindrical shaped discharge tubes are cold cathode fluorescent lamps.

35. A display apparatus comprising:
a display panel; and
a surface light source unit applying light to the display panel, wherein brightness of the light applied to the display panel by the surface light source unit is partially controlled in response to properties of image signals applied to the display panel.

36. The display apparatus of claim 35, wherein the display panel includes two substrates and a liquid crystal layer formed between the two substrates and controlling transmission of light provided from the surface light source unit.

37. The display apparatus of claim 35, wherein the display panel includes a plurality of image display areas, the surface light source unit includes a plurality of luminance control areas, and the surface light source unit controls brightness of the luminance control areas in response to luminance properties of images displayed in the image display areas.

38. The display apparatus of claim 37, wherein the surface light source unit includes:
a flat fluorescent lamp having a plurality of discharge electrode pairs;
a backlight control part detecting luminance signals and sync signals from the image signals, and detecting a maximum luminance value by comparing luminance values with respect to all pixels of each of the image display areas;
a horizontal driving part applying power to discharge electrodes, within the discharge electrode pairs, horizontally disposed in the flat fluorescent lamp, the power applied in response to controls of the backlight control part; and
a vertical driving part applying power to discharge electrodes, within the discharge electrode pairs, vertically disposed in the flat fluorescent lamp, the power applied in response to controls of the backlight control part.

39. The display apparatus of claim 38, wherein the backlight control part comprises:
a luminance signal detecting part detecting luminance signals from the image signals;
a sync signal detecting part detecting horizontal and vertical sync signals from the image signals;
a timing control part generating timing control signals, based on the horizontal and vertical sync signals from the sync signal detecting part;
a maximum voltage detecting part detecting a maximum voltage with respect to each horizontal area from the luminance signals in response to the timing control signals, and the maximum voltage detecting part detecting a maximum voltage with respect to each vertical area within each horizontal area;
a first register storing a maximum voltage value with respect to each horizontal area; and
a second register storing a maximum voltage value with respect to a vertical area corresponding to each horizontal area.

40. The display apparatus of claim 39, wherein the luminance signal detecting part includes a low pass filter.

41. The display apparatus of claim 40, wherein the low pass filter blocks high frequency signals having color signal components and transmits low frequency signals having luminance signal components.

42. The display apparatus of claim 38, wherein the horizontal driving part includes:
a first switching control circuit outputting first switching control signals by comparing a maximum voltage value of a horizontal area and a ground voltage value;
a first switching circuit outputting alternating current voltage from an inverter as on/off switching in response to the first switching control signals; and
a first transforming circuit boosting the alternating current voltage from the first switching circuit.

43. The display apparatus of claim 42, wherein the first switching control signals have a square waveform.

44. The display apparatus of claim 42, wherein the first switching control circuit includes:
a first triangular wave generating unit outputting the ground voltage value; and
a plurality of first comparators disposed in parallel and outputting the first switching control signals by comparing a maximum voltage value of a plurality of horizontal areas and the ground voltage value.

45. The display apparatus of claim 42, wherein the vertical driving part includes:
a second switching control circuit outputting a second control signals by comparing a maximum voltage value of a vertical area and a ground voltage value;
a second switching circuit outputting alternating current voltage from the inverter as on/off switching in response to the second switching control signals; and
a second transforming circuit boosting the alternating current voltage from the second switching circuit.

46. The display apparatus of claim 45, wherein the second switching control signals have a square waveform.

47. The display apparatus of claim 45, wherein the second switching control circuit includes:
a second triangular wave generating unit outputting the ground voltage value; and
a plurality of second comparators disposed in parallel and outputting the second switching control signals by comparing a maximum voltage value of a plurality of vertical areas and the ground voltage value.

48. A method of controlling a display apparatus having a display panel and a surface light source unit applying light to the display panel, the method comprising:
detecting luminance signals and sync signals from image signals outputted from an external image signal source;
detecting a maximum luminance value according to each image display area formed in the display panel; and
separately driving the surface light source unit, based on a maximum luminance value according to each luminance control area formed in the surface light source unit.

49. The method of controlling display apparatus of claim 48, wherein detecting a maximum luminance value comprises:
detecting a maximum voltage value according to each vertical area from each horizontal area; and
detecting a maximum voltage with respect to each horizontal area.

50. A method of reducing power consumption in a display apparatus, the method comprising:
segmenting a surface light source unit into discrete sections;
detecting image signals applied to a display panel;
independently controlling the sections of the surface light source unit at least partially in response to the image signals and applying light from the sections of the surface light source unit to the display panel.

51. The method of claim 50, further comprising:
detecting ambient light;
wherein independently controlling the sections of the surface light source unit further includes responding to ambient light.
